(19) United States
(12) Patent Application Publication
(10) Pub. No.: US 2025/0081133 A1
(43) Pub. Date: Mar. 6, 2025

(54) MULTIPURPOSE POSITIONING PROTOCOL FOR ASYNCHRONIZED RADIO NETWORKS

(71) Applicant: HERE Global B.V., Eindhoven (NL)

(72) Inventors: Tuomo HONKANEN, Tampere (FI); Jani KAPPI, Tampere (FI)

(73) Assignee: HERE Global B.V., Eindhoven (NL)

(21) Appl. No.: 18/460,859

(22) Filed: Sep. 5, 2023

(51) Int. Cl. H04W 56/00

(52) U.S. Cl. CPC H04W 56/002

(57) ABSTRACT

Embodiments provide methods for positioning user equipment (UE) and/or base stations (BSs) within a communication cluster of base stations (CCBS) based on radio transmissions transmitted during a broadcast of a communication synchronization frame (CSF). Embodiments are configured to generate a BS message associated with a current configuration of a UE as well as an almanac message associated with a current location of the UE. Embodiments can also cause transmission of at least one of the BS message or the almanac message based on a respective transmission time slot associated with a CSF, where the CSF is broadcast across a CCBS, and where the CSF is configured to synchronize one or more communications of one or more BSs associated with the CCBS.

### TECHNICAL FIELD

An example embodiment of the present disclosure generally relates to communication systems and, more particularly, to methods for positioning one or more apparatuses within a communication cluster of base stations based on one or more radio transmissions transmitted during a broadcast of a communication synchronization frame across the communication cluster of base stations.

### BACKGROUND

When determining 3D positional information for a plurality of apparatuses (e.g., one or more autonomous robots, pieces of user equipment (UEs), and/or base stations (BSs)) that are located indoors or in deep urban settings, many conventional positioning methods utilize short range radio transmissions (e.g., Wi-Fi or Bluetooth Low Energy (BLE)) and/or, in some contexts, sensor-based dead reckoning. However, in many scenarios, these conventional methods can only provide limited positional accuracy (e.g., accuracy within two or three meters) which is not sufficient for many modern day use-cases such as, for example, autonomous robotics applications. Furthermore, current solutions related to the simultaneous positioning of a plurality of apparatuses (e.g., UEs, BSs, and/or autonomous devices) require a great amount of technological resources such as, for example, energy resources and/or computational resources.

Applicant has discovered various technical problems associated with conventional methods, systems, and tools for positioning one or more such apparatuses within a communication environment. Through applied effort, ingenuity, and innovation, Applicant has solved many of these identified problems by developing the embodiments of the present disclosure, which are described in detail below.

### SUMMARY

Methods, apparatuses, and computer program products are provided in accordance with an example embodiment for positioning one or more pieces of user equipment (UE) and/or base stations (BSs) within a communication cluster of base stations (CCBS) based on radio transmissions transmitted during a broadcast of a communication synchronization frame (CSF).

In accordance with a first aspect of the present disclosure, a computer-implemented method for positioning one or more UEs and/or BSs within a CCBS based on radio transmissions transmitted during a broadcast of a CSF is provided. The computer-implemented method is performable by one or more specially configured computing device(s) embodied in hardware, software, firmware, and/or any combination thereof, for example as described herein.

In one example embodiment, a computer-implemented method includes generating a base station message associated with a current configuration of the apparatus, where the base station message is configured based at least in part on one or more base station message parameters associated with one or more portions of data related to the current configuration of the apparatus. The computer-implemented method also includes generating an almanac message associated with a current location of the apparatus, where the almanac message is configured based at least in part on one or more almanac message parameters associated with one or more portions of data related to the current location of the apparatus. The computer-implemented method also includes causing transmission of at least one of the base station message or the almanac message based at least in part on a respective transmission time slot of a plurality of transmission time slots associated with a communication synchronization frame, where the communication synchronization frame is broadcast across a communication cluster of base stations (CCBS), and where the communication synchronization frame is configured to synchronize one or more communications of one or more base stations associated with the CCBS.

The computer-implemented method further includes where the communication synchronization frame is configured based at least in part on the plurality of transmission time slots, and where the plurality of transmission time slots comprises at least one of one or more base station slots, one or more almanac slots, one or more command slots, one or more command response slots, or one or more common slots.

The computer-implemented method further includes determining that the apparatus is associated with an initiator role, where the initiator role indicates that the apparatus is configured to set a timing synchronization associated with the communication synchronization frame for the one or more base stations associated with the CCBS. The computer-implemented method also includes, in response to determining that the apparatus is associated with the initiator role, setting a clock level value associated with the apparatus to a predefined initial clock level value. The computer-implemented method also includes causing initiation of the broadcast of the communication synchronization frame in the CCBS.

The computer-implemented method further includes, prior to generating and causing the transmission of the at least one of the base station message or the almanac message, determining whether the apparatus has an assigned base station slot associated with the communication synchronization frame. The computer-implemented method also includes, in response to determining the apparatus does not have an assigned base station slot, joining the communication synchronization frame by at least generating a join message, where the join message is a request to cause the apparatus to join the communication synchronization frame at a requested base station slot, and causing transmission of the join message during a command slot associated with the communication synchronization frame.

The computer-implemented method further includes where the join message is associated with one or more join message parameters, and where the one or more join message parameters comprise at least one of a join message identifier, a base station identifier, a hardware version number, a software version number, a software checksum, or the requested base station slot.

The computer-implemented method further includes where the join message is transmitted to a target base station of the one or more base stations based on an amount of communication synchronization frames the target base station has been associated with relative to the one or more respective base stations.

The computer-implemented method further includes, in response to causing the transmission of the join message, receiving, from the target base station, a join response message. The computer-implemented method also includes determining, based on the join response message, whether the apparatus is able to join the communication synchronization frame at the requested base station slot. The computer-implemented method also includes, in response to determining that the apparatus is able to join the communication synchronization frame, joining the communication synchronization frame at the requested base station slot.

The computer-implemented method further includes where the join response message comprises one or more join response message parameters, and where the one or more join response message parameters comprise at least one of a join response message identifier, the base station identifier, the requested base station slot, or a join status indication.

The computer-implemented method further includes detecting a base station transmission collision, where the base station transmission collision is an instance in which two or more base stations of the one or more base stations associated with the CCBS have transmitted respective base station messages via a common base station slot associated with the communication synchronization frame. The computer-implemented method also includes, in response to detecting the base station transmission collision, generating a collision message, where the collision message comprises a collision message identifier and a base station slot number associated with the common base station slot associated with the base station transmission collision. The computer-implemented method also includes reserving a collision message slot in a forthcoming base station message associated with the apparatus. The computer-implemented method also includes causing transmission of the collision message via the reserved collision message slot during transmission of the forthcoming base station message.

In accordance with a second aspect of the disclosure, another computer-implemented method for positioning one or more UEs and/or BSs, within a CCBS based on radio transmissions transmitted during a broadcast of a CSF is provided. The computer-implemented method is performable by one or more specially configured computing device(s) embodied in hardware, software, firmware, and/or any combination thereof, for example as described herein.

In one example embodiment, a computer-implemented method includes receiving one or more communications from one or more base stations associated with a CCBS, where the one or more communications are associated with one or more respective transmission time slots associated with a communication synchronization frame, where the one or more communications comprise at least one of one or more base station messages associated with a current configuration of the one or more respective base stations or one or more almanac messages associated with a current location of the one or more respective base stations. The computer-implemented method also includes determining, based at least in part on the one or more communications, a location of the apparatus.

The computer-implemented method further includes determining a value of a smallest received clock level from one or more base station messages associated with the one or more respective communications. The computer-implemented method also includes incrementing the value of the smallest received clock level by a predefined amount. The computer-implemented method also includes setting a clock level value associated with the apparatus based on the incremented value, where the clock level value will be indicated in one or more subsequent base station messages transmitted by the apparatus.

The computer-implemented method further includes determining whether a value of a clock level associated with a respective base station message of the one or more base station messages associated with the one or more communications exceeds a predetermined clock level threshold. The computer-implemented method also includes, in response to determining that the value of the clock level associated with the respective base station message exceeds the predetermined clock level threshold, determining whether the apparatus is associated with an initiator role, where the initiator role indicates that the apparatus is configured to set a timing synchronization associated with the communication synchronization frame for the one or more base stations associated with the CCBS. The computer-implemented method also includes, in response to determining that the apparatus is associated with the initiator role, setting a clock level value associated with the apparatus to a predefined initial clock level value. The computer-implemented method also includes causing initiation of a broadcast of a new communication synchronization frame in the CCBS.

The computer-implemented method further includes receiving a join message from a requesting base station of the one or more base stations associated with the CCBS, where the join message is a request to cause the requesting base station to join the communication synchronization frame at a requested base station slot. The computer-implemented method also includes, in response to receiving the join message from the requesting base station, determining, based at least in part on the join message, whether the requesting base station is able to join the communication synchronization frame. The computer-implemented method also includes generating, based on determining whether the requesting base station is able to join the communication synchronization frame, a join response message. The computer-implemented method also includes causing transmission of the join response message to the requesting base station.

The computer-implemented method further includes where the join response message comprises one or more join response message parameters, and where the one or more join response message parameters comprise at least one of a join response message identifier, a base station identifier associated with the requesting base station, the requested base station slot, or a join error indication.

The computer-implemented method further includes receiving a collision message. The computer-implemented method also includes, in response to receiving the collision message, determining if the apparatus is an initiator of the communication synchronization frame. The computer-implemented method also includes, in response to determining that the apparatus is not the initiator of the communication synchronization frame, joining the communication synchronization frame by at least generating a join message, where the join message is a request to cause the apparatus to join the communication synchronization frame at a requested base station slot and causing transmission of the join message during a command slot associated with the communication synchronization frame. The computer-implemented method also includes receiving, from a target base station, a join response message in response to transmitting the join message during the command slot. The computer-implemented method also includes determining, based on the join response message, whether the apparatus is able to join the communication synchronization frame at the requested base station slot. The computer-implemented method also includes, in response to determining that the apparatus is able to join the communication synchronization frame, joining the communication synchronization frame at the requested base station slot.

In accordance with a third aspect of the disclosure, an apparatus for positioning one or more UEs and/or BSs within a CCBS based on radio transmissions transmitted during a broadcast of a CSF is provided. In one example embodiment, the apparatus includes at least one or more processors communicatively coupled at least one memory including computer program code. The at least one memory and the computer program code are configured to, with at least one processor, cause the apparatus to perform any one of the example computer-implemented methods described herein.

In accordance with a fourth aspect of the disclosure, a computer program product for positioning one or more UEs and/or BSs within a CCBS based on radio transmissions transmitted during a broadcast of a CSF is provided. In one example embodiment, the computer program product includes at least one non-transitory computer-readable storage medium having computer program code instructions stored thereon that, in execution with at least one processor, configures the computer program product for performing any one of the example computer-implemented methods described herein.

In accordance with a fifth aspect of the disclosure, an apparatus for positioning one or more UEs and/or BSs within a CCBS based on radio transmissions transmitted during a broadcast of a CSF is provided. The apparatus includes means for generating a base station message associated with a current configuration of the apparatus, where the base station message is configured based at least in part on one or more base station message parameters associated with one or more portions of data related to the current configuration of the apparatus. The apparatus also includes means for generating an almanac message associated with a current location of the apparatus, where the almanac message is configured based at least in part on one or more almanac message parameters associated with one or more portions of data related to the current location of the apparatus. The apparatus also includes means for causing transmission of at least one of the base station message or the almanac message based at least in part on a respective transmission time slot of a plurality of transmission time slots associated with a communication synchronization frame, where the communication synchronization frame is broadcast across a communication cluster of base stations (CCBS), and where the communication synchronization frame is configured to synchronize one or more communications of one or more base stations associated with the CCBS.

The apparatus further includes means for where the communication synchronization frame is configured based at least in part on the plurality of transmission time slots, and where the plurality of transmission time slots comprises at least one of one or more base station slots, one or more almanac slots, one or more command slots, one or more command response slots, or one or more common slots.

The apparatus further includes means for determining that the apparatus is associated with an initiator role, where the initiator role indicates that the apparatus is configured to set a timing synchronization associated with the communication synchronization frame for the one or more base stations associated with the CCBS. The apparatus also includes means for, in response to determining that the apparatus is associated with the initiator role, setting a clock level value associated with the apparatus to a predefined initial clock level value. The apparatus also includes means for causing initiation of the broadcast of the communication synchronization frame in the CCBS.

The apparatus further includes means for, prior to generating and causing the transmission of the at least one of the base station message or the almanac message, determining whether the apparatus has an assigned base station slot associated with the communication synchronization frame. The apparatus also includes means for, in response to determining the apparatus does not have an assigned base station slot, joining the communication synchronization frame by at least generating a join message, where the join message is a request to cause the apparatus to join the communication synchronization frame at a requested base station slot, and causing transmission of the join message during a command slot associated with the communication synchronization frame.

The apparatus further includes means for where the join message is associated with one or more join message parameters, and where the one or more join message parameters comprise at least one of a join message identifier, a base station identifier, a hardware version number, a software version number, a software checksum, or the requested base station slot.

The apparatus further includes means for where the join message is transmitted to a target base station of the one or more base stations based on an amount of communication synchronization frames the target base station has been associated with relative to the one or more respective base stations.

The apparatus further includes means for, in response to causing the transmission of the join message, receiving, from the target base station, a join response message. The apparatus also includes means for determining, based on the join response message, whether the apparatus is able to join the communication synchronization frame at the requested base station slot. The apparatus also includes means for, in response to determining that the apparatus is able to join the communication synchronization frame, joining the communication synchronization frame at the requested base station slot.

The apparatus further includes means for where the join response message comprises one or more join response message parameters, and where the one or more join response message parameters comprise at least one of a join response message identifier, the base station identifier, the requested base station slot, or a join status indication.

The apparatus further includes means for detecting a base station transmission collision, where the base station transmission collision is an instance in which two or more base stations of the one or more base stations associated with the CCBS have transmitted respective base station messages via a common base station slot associated with the communication synchronization frame. The apparatus also includes means for, in response to detecting the base station transmission collision, generating a collision message, where the collision message comprises a collision message identifier and a base station slot number associated with the common base station slot associated with the base station transmission collision. The apparatus also includes means for reserving a collision message slot in a forthcoming base station message associated with the apparatus. The apparatus also includes means for causing transmission of the collision message via the reserved collision message slot during transmission of the forthcoming base station message.

In accordance with a sixth aspect of the disclosure, another apparatus for positioning one or more UEs and/or BSs within a CCBS based on radio transmissions transmitted during a broadcast of a CSF is provided. The apparatus includes means for receiving one or more communications from one or more base stations associated with a CCBS, where the one or more communications are associated with one or more respective transmission time slots associated with a communication synchronization frame, where the one or more communications comprise at least one of one or more base station messages associated with a current configuration of the one or more respective base stations or one or more almanac messages associated with a current location of the one or more respective base stations. The apparatus also includes means for determining. based at least in part on the one or more communications, a location of the apparatus.

The apparatus further includes means for determining a value of a smallest received clock level from one or more base station messages associated with the one or more respective communications. The apparatus also includes means for incrementing the value of the smallest received clock level by a predefined amount. The apparatus also includes means for setting a clock level value associated with the apparatus based on the incremented value, where the clock level value will be indicated in one or more subsequent base station messages transmitted by the apparatus.

The apparatus further includes means for determining whether a value of a clock level associated with a respective base station message of the one or more base station messages associated with the one or more communications exceeds a predetermined clock level threshold. The apparatus also includes means for, in response to determining that the value of the clock level associated with the respective base station message exceeds the predetermined clock level threshold, determining whether the apparatus is associated with an initiator role, where the initiator role indicates that the apparatus is configured to set a timing synchronization associated with the communication synchronization frame for the one or more base stations associated with the CCBS. The apparatus also includes means for, in response to determining that the apparatus is associated with the initiator role, setting a clock level value associated with the apparatus to a predefined initial clock level value. The apparatus also includes means for causing initiation of a broadcast of a new communication synchronization frame in the CCBS.

The apparatus further includes means for receiving a join message from a requesting base station of the one or more base stations associated with the CCBS, where the join message is a request to cause the requesting base station to join the communication synchronization frame at a requested base station slot. The apparatus also includes means for, in response to receiving the join message from the requesting base station, determining, based at least in part on the join message, whether the requesting base station is able to join the communication synchronization frame. The apparatus also includes means for generating, based on determining whether the requesting base station is able to join the communication synchronization frame, a join response message. The apparatus also includes means for causing transmission of the join response message to the requesting base station.

The apparatus further includes means for where the join response message comprises one or more join response message parameters, and where the one or more join response message parameters comprise at least one of a join response message identifier, a base station identifier associated with the requesting base station, the requested base station slot, or a join error indication.

The apparatus further includes means for receiving a collision message. The apparatus also includes means for, in response to receiving the collision message, determining if the apparatus is an initiator of the communication synchronization frame. The apparatus also includes means for, in response to determining that the apparatus is not the initiator of the communication synchronization frame, joining the communication synchronization frame by at least generating a join message, where the join message is a request to cause the apparatus to join the communication synchronization frame at a requested base station slot and causing transmission of the join message during a command slot associated with the communication synchronization frame. The apparatus also includes means for receiving, from a target base station, a join response message in response to transmitting the join message during the command slot. The apparatus also includes means for determining, based on the join response message, whether the apparatus is able to join the communication synchronization frame at the requested base station slot. The apparatus also includes means for, in response to determining that the apparatus is able to join the communication synchronization frame, joining the communication synchronization frame at the requested base station slot.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described certain example embodiments in general terms, reference will now be made to the accompanying drawings, which are not necessarily drawn to scale, and wherein:

FIG. 1 is a diagram of a communications environment comprising a plurality of communication clusters of base stations (CCBSs) configured in accordance with one or more example embodiments of the present disclosure;

FIG. 2 is a block diagram of an apparatus that can be configured to provide precise positioning for one or more apparatuses within a CCBS in accordance with one or more example embodiments of the present disclosure;

FIG. 3 illustrates relative frequency ranges and energy outputs associated with various respective radio frequency transmissions in accordance with one or more example embodiments of the present disclosure;

FIG. 4 illustrates an example ultra-wideband (UWB) communication transmission frame configured in accordance with one or more example embodiments of the present disclosure;

FIG. 5 illustrates an example communication synchronization frame (CSF) configured to be broadcast across a respective CCBS in accordance with one or more example embodiments of the present disclosure;

FIG. 6 illustrates a flowchart depicting a method associated with a CSF joining procedure in accordance with one or more example embodiments of the present disclosure;

FIG. 7 illustrates a flowchart depicting a method for mitigating a BS transmission collision in accordance with one or more example embodiments of the present disclosure;

FIG. 8 illustrates a flowchart depicting a method for managing one or more CSFs based in part on a predetermined clock level threshold in accordance with one or more example embodiments of the present disclosure;

FIG. 9 illustrates a flowchart depicting a method for transmitting one or more BS messages and/or almanac messages associated with a respective CSF in accordance with one or more example embodiments of the present disclosure; and

FIG. 10 illustrates a flowchart depicting a method for determining a position of an apparatus associated with a respective CCBS based in part on one or more messages associated with a respective CSF in accordance with one or more example embodiments of the present disclosure.

### DETAILED DESCRIPTION

Some embodiments of the present disclosure will now be described more fully hereinafter with reference to the accompanying drawings, in which some, but not all, embodiments of the present disclosure are shown. Indeed, various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile, or non-volatile memory), may be differentiated from a “computer-readable transmission medium,” which refers to an electromagnetic signal.

### Overview

Example communication systems, frameworks, and/or associated techniques of the present disclosure may be configured to provide methods for positioning one or more apparatuses (e.g., networking elements such as a plurality of user equipment (UEs) and/or base stations (BSs), Internet-of-Things (IoT) devices, autonomous robots, and/or the like) within a communication cluster of base stations (CCBS) based on one or more radio transmissions transmitted during a broadcast of a communication synchronization frame (CSF) across the CCBS. However, it should be understood that the present disclosure is not limited to the particular types of communication systems and/or processes disclosed. For example, while the present disclosure may describe certain embodiments in conjunction with 5G/6G communications system technologies and/or ultra-wideband (UWB) communications system technologies, other embodiments also apply to and comprise other networks and network technologies, such as 3G, 4G, Long Term Evolution (LTE), etc., without limitation.

Additionally, in accordance with an illustrative embodiment implemented in a 5G communication system environment, one or more 3GPP standards, specifications, and/or protocols provide further explanation of UE and core network elements/entities/functions and/or operations performed by the UE and the core network elements/entities/functions, e.g., the 3GPP System Aspects (SA) Working Group 5 (3GPP SA5), the 3GPP RAN 3. Other 3GPP standards, specifications and/or protocols may provide other conventional details that one of ordinary skill in the art will realize. However, while illustrative embodiments are well-suited for implementation associated with the above-mentioned 3GPP standards, embodiments are not necessarily intended to be limited to any particular standards.

As described herein, conventional methods for determining 3D positional information for a plurality of apparatuses (e.g., UEs, BSs, IoT devices, autonomous robots, and/or the like) that are located indoors or in deep urban settings rely on short range radio transmissions (e.g., Wi-Fi or Bluetooth Low Energy (BLE)) and/or, in some contexts, sensor-based dead reckoning. However, in many scenarios, these conventional methods can only provide limited positional accuracy (e.g., accuracy within two or three meters) which is not sufficient for many modern day use-cases such as, for example, autonomous robotics applications where it is desirable to determine a precise location associated with one or more robots navigating within a warehouse environment.

Various conventional positioning methods include utilizing various 5G/6G or ultra-wideband (UWB) radio-based positioning techniques. A UWB radio-based system can provide sub-meter (e.g., below 10 cm) positioning accuracy. To achieve such accuracy, communications networks need to be synchronized by, for example, using various synchronization techniques such as time of arrival (TOA) measurements or observed time difference of arrival (OTDOA) measurements. However, synchronization requirements associated with such techniques limit the achievable accuracy of the respective positioning solution and increase hardware and/or deployment costs related to the communications network.

In 5G networks, apparatus positioning (e.g., UE positioning) is based in part on measurements related to the apparatus and a respective networking element (e.g., a gNB) and a location of the apparatus is computed in a location server (e.g., via the location management function (LMF) associated with the 5G network). In 3GPP standards release Rel-16 for 5G, six different radio access technology (RAT)-dependent techniques were introduced, namely new radio (NR) enhanced cell identification (E-CID), downlink time difference of arrival (DL-TDoA), uplink time difference of arrival (UL-TDoA), downlink angle of departure (DL-AoD), uplink angle of arrival (UL AoA) and multi-cell round trip time (multi-RTT). High precision positioning techniques (e.g., such as multi-RTT) were introduced, based on learning from long-term evolution (LTE), a fourth generation 4G standard, to address positioning errors caused by synchronization offsets between BSs. However, to mitigate time synchronization issues, the high-precision positioning solutions (e.g., multi-RTT techniques) require copious resources (e.g., technological resources, energy resources, and/or computational resources) and provide only limited throughput.

In both UWB and 5G communication networks, high positioning accuracy (e.g., sub-meter accuracy) requires high level (e.g., sub-nanosecond) synchronization between transmission/reception points (TRP) (e.g., between one or more BSs and/or UEs). The use of RTT and multi-RTT techniques consume BS resources and limits the number of simultaneous apparatuses (e.g., UEs, IoT devices, autonomous robots, etc.) that may access the communications service. Further inefficiencies in conventional positioning methods relate to location service designs that are based on a request-and-response process (e.g., a data transmission acknowledgement process). Such methods do not support the requirement of high-rate feedback of location information, nor apparatus service handovers between network cells (e.g., between multiple network elements, BSs, etc.), to allow for the seamless tracking of an apparatus location and/or pose (e.g., orientation, heading, etc.) within a 3D environment.

The UWB physical layer (PHY) is based on ultra-wideband impulse radio technology (e.g., as described by IEEE 802.15.4). UWB PHY differs substantially from conventional narrowband radio frequency (RF) and spread spectrum technologies (SS), such as Bluetooth Technology and Wi-Fi (e.g., 802.11 a/g). For example, UWB communication systems utilize a train of impulses rather than a modulated sine wave to transmit information. This unique characteristic makes UWB transmissions perfect for precise ranging and/or positioning applications.

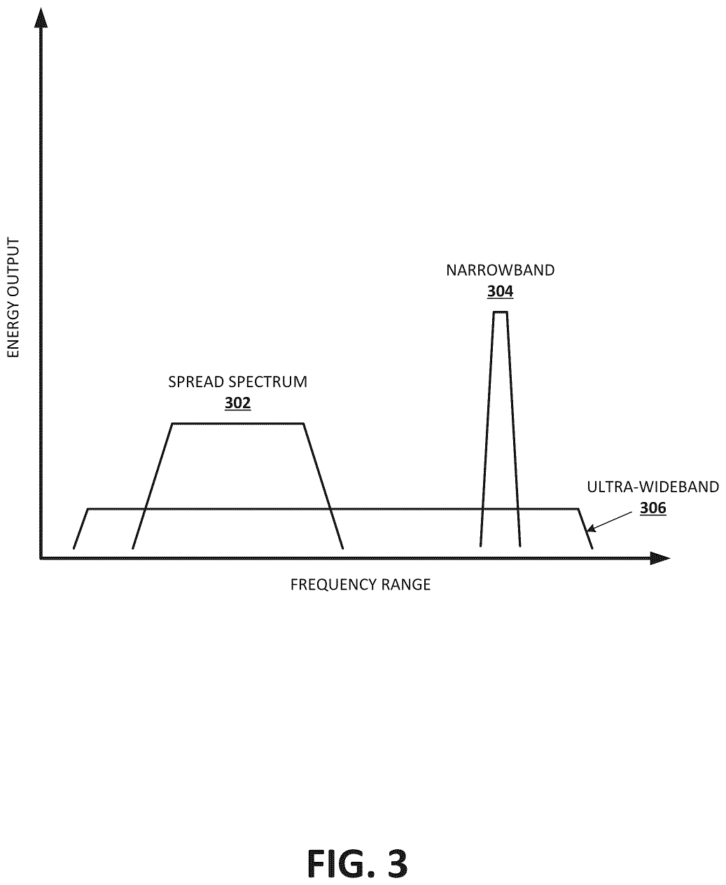

Referencing FIG. 3, the difference between the relative frequency ranges and energy outputs for a spread spectrum transmission 302, a narrowband transmission 304, and a UWB transmission 306 is illustrated. As shown in FIG. 3, a signal pulse associated with the UWB transmission 306 occupies a wide frequency band and the rising edge of the signal pulse is very steep and is therefore easy to detect in a noisy radio environment which allows an apparatus (e.g., a UE, BS, IoT device, and/or the like) to measure an arrival time of the respective signal accurately. Furthermore, the signal pulses associated UWB transmissions have a short duration relative to other transmission types (e.g., the spread spectrum transmission 302 and/or the narrowband transmission 304) and, in many contexts, typically take no more than two nanoseconds.

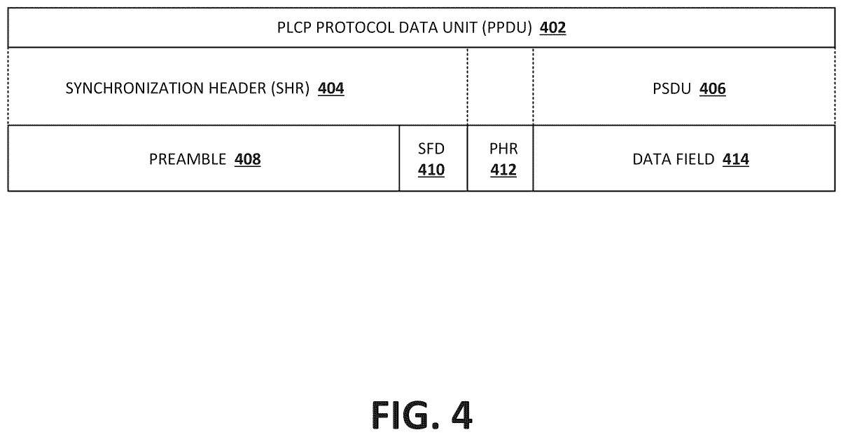

UWB communications are based on the transmission and reception of transmission frames or units. Referencing FIG. 4, UWB transmissions, in many contexts, are configured in a physical layer convergence procedure (PLCP) protocol data unit (PPDU) 402. The PPDU 402 begins with a synchronization header (SHR) 404 and is followed by a PLCP service data unit (PSDU) 406. As shown in FIG. 4, the SHR 404 comprises a plurality of bits related to a preamble 408 and a start of the frame delimiter (SFD) 410. The SHR 404 is followed by a PHY header (PHR) 412 that defines a length and data rate of the data payload of the PPDU 402. The PSDU 406 comprises a data field 414 associated with the data payload of the PPDU 402.

Due to the nature of UWB transmissions, UWB signal pulses can be distinguished in noisy radio environments. Furthermore, the UWB signals are resistant to multipath effects in which an antenna of a receiving apparatus (e.g., a UE antenna or BS antenna) receive a radio frequency signal via one or more transmission routes which can lead to radio interference and/or distortion of a respective signal which can impact positioning accuracy. The aforementioned aspects of UWB transmissions give UWB communication systems an advantage over conventional communication systems with transmission range limitations, such as communication systems that utilize narrowband signals. Furthermore, UWB communications systems are regulated to using a strict spectral mask (e.g., as mandated by the federal communication commission (FCC)). As such, the transmission power used for UWB transmission lies at the noise floor, meaning that UWB communications do not interfere with other radio communication systems operating in the same frequency bands.

The UWB PHY specifies operation in three distinct bands: a sub-gigahertz band (e.g., 250-750 MHz), a low band (e.g., 3244-4742 MHz), and a high band (e.g., 5944-10234 MHz). UWB-capable devices (e.g., UEs, BSs, etc.) associated with each band operate independently of the other bands, and all three bands are subject to various regulatory constraints in different regions of the world.

As described herein, communications systems that utilize conventional positioning techniques (e.g., RTT or multi-RTT) can only support a limited number of apparatuses (e.g., UEs, trackers, IoT devices, etc.) at given time due to resource limitations (e.g., due in part to a limited number of accessible transmission time slots associated with conventional transmission frames). Furthermore, in the case of UWB systems, regulatory requirements limit the radio signal allocation which further reduces the amount of accessible resources (e.g., further reduces the number of accessible transmission time slots).

Embodiments of the present disclosure provide methods, systems, apparatuses, and computer program products configured to provide both 5G/6G and UWB signaling that enable a plurality of improved uses of current radio infrastructure. For example, various embodiments of the present disclosure provide simultaneous multi-RTT between a plurality of BSs (e.g., known as “meshing”) as well as a plurality of advanced, active apparatuses (e.g., autonomous robots, various UEs, IoT devices, and/or the like) while simultaneously providing a robust positioning solution for a large number of passive apparatuses (e.g., trackers, downlink-exclusive devices, and/or the like) associated with a communications environment.

### EXAMPLE SYSTEMS AND APPARATUSES OF THE PRESENT DISCLOSURE

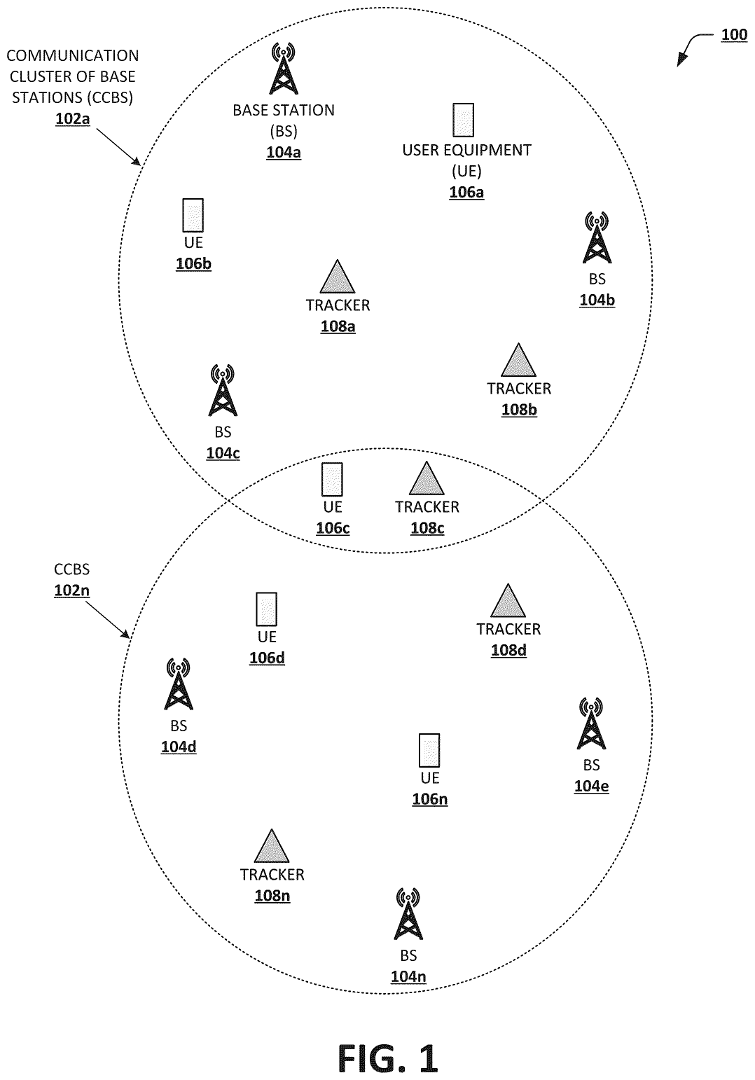

FIG. 1 is a diagram of a communications environment 100 comprising plurality of communication clusters of base stations (CCBSs) 102a-n configured in accordance with one or more example embodiments of the present disclosure. However, it is to be appreciated that embodiments are not limited to the network configurations illustrated herein or otherwise described below and that the one or more components associated with the communications environment 100, and/or the one or more methods associated therewith, may be deployed in other applications. By way of example, the communications environment 100 and the one or more components associated with the communications environment 100 may be deployed within a radio access technology architecture. However, the system may be deployed in other applications including within other communication networks including, for example, LTE advanced (LTE-A), a universal mobile telecommunications system (UMTS) radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access node (AN) eligible to access the 5G core network such as an untrusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the NG RAN/gNB.

In various contexts, a communications environment 100 may be a closed communications environment associated with a particular building (e.g., a multi-level building), a campus comprising a plurality of buildings (e.g., single-or multi-level buildings), a particular outdoor environment, and/or the like. As shown in FIG. 1, in various embodiments, one or more CCBSs comprised in the plurality of CCBSs 102a-n can be associated with one or more base stations (BSs) 104a-n, one or more pieces of user equipment (UEs) 106a-n, and/or or one or more trackers 108b. As used herein, the term base station (BS) may also be referred as a beacon, access node, eNodeB (eNB), gNodeB (gNB), wireless transmitter, transceiver, and/or any other type of networking element capable of transmitting and/or receiving data from one of more UEs, mobile devices, computing devices, radio devices, wireless devices, IoT devices, networking devices, smartphones, tablet computers, and/or the like.

In some contexts, a particular CCBS 102a may be closed communications network configured to facilitate the communications and/or positioning of the one or more BSs 104a-n, the one or more UEs 106a-n, and/or the one or more trackers 108b. In various contexts, a particular CCBS 102a may be associated with a particular floor of a multi-level building. For example, in some embodiments, a CCBS 102a may be associated with a first floor of a multi-level building and a CCBS 102b may be associated with a second floor of a multi-level building. In various other embodiments, a CCBS 102a may be associated with a first section of a particular floor of a building (e.g., a first floor), and a CCBS 102b may be associated with a second section of the same floor of the building (e.g., the first floor). In various embodiments, one or more components of a particular CCBS 102a (e.g., the one or more BSs 104a-n and/or the one or more UEs 106a-n) may be configured to communicate with one or more other communications systems unrelated to the CCBS 102a. For example, one or more components of a particular CCBS 102a (e.g., the one or more BSs 104a-c and/or the one or more UEs 106a-c) may be configured to communicate with a different CCBS (e.g., a CCBS 102b) and/or one or more pre-existing communication systems (e.g., 4G LTE systems, 5G systems, 6G systems, etc.).

Additionally, in various contexts, a particular CCBS 102a may be associated with a predefined set of radio channel parameters (e.g., UWB specific parameters) such that one or more communications of the one or more components of the particular CCBS 102a (e.g., the one or more BSs 104a-c and/or the one or more UEs 106a-c) are generated and/or transmitted based at least in part on the predefined set of radio channel parameters. In various embodiments, the predefined set of radio channel parameters may comprise at least one of a UWB channel number, a pulse repetition frequency (PRF), and/or a preamble code (e.g., a preamble code to be used with a respective SHR 404). In various embodiments, two or more CCBSs 102a-n may be associated with two or more respective, distinct sets of radio channel parameters so that the one or more components (e.g., the one or more BSs 104a-n and/or the one or more UEs 106a-n) of the two or more CCBSs 102a-n will not interfere with one another while generating, transmitting, and/or receiving one or more respective messages.

In various embodiments, each respective radio channel parameter of a predefined set of radio channel parameters may be associated with a predetermined number of bits such that the predefined set of radio channel parameters may be encoded into a single byte. For example, bits 0-3 may indicate a UWB channel number value of 2-7, bit 4 may indicate a PRF (e.g., a bit value of 0 indicates a 16 MHz PRF, and a bit value of 1 indicates a 64 MHz PRF), bits 5-6 may indicate a preamble code (e.g., to be selected from a UWB channel/PRF-specific table), and bit 7 may be a reserved bit set to a predetermined value (e.g., a bit value of 0).

In various embodiments, one or more BSs (e.g., BSs 104a-c) associated with a respective CCBS 102a may be configured as respective network elements (e.g., ANs, radio ANs (RANs), TRPs, and/or the like) that can be used for positioning one or more apparatuses (e.g., one or more other BSs 104a-c, one or more UEs (e.g., UEs 106a-c) and/or one or more trackers (e.g., trackers 108a-c). For example, in various embodiments, a BS 104a can be configured as a next generation node B (gNB) (which may also be split in a centralized unit (CU) and a distributed unit (DU) part) and/or other AN types, such as evolved node Bs (eNBs), node Bs, and/or N3IWF, or any other types of ANs such as WLAN access points, as well as one or more associated radio network control functions. The BS 104a and radio network control functions may be logically separate entities, but in a given embodiment may be implemented in the same physical network element, such as, for example, a BS router or femto cellular access point.

As will be appreciated by one of skill in the art, any variety of ANs may also implement similar operations, functions, etc. In some example embodiments, a BS 104a may be operatively coupled to a 5G core network function, such as via an NG interface. The core network function may include an access and mobility management function (AMF), session management function (SMF), representative network function (NF-X), or any of core network function. A core network function may be an element of the core network (CN) part of the communication system that is responsible for one or more associated operations. Additionally, the BS 104a is configured to generate, transmit, and/or receive one or more UWB transmissions.

In various embodiments, the one or more BSs 104a-n can be permanently installed in respective fixed locations (e.g., installed in one or more respective poles, walls, ceilings, roofs, and/or the like) associated with a particular building. Additionally or alternatively, in various embodiments, one or more BSs 104a-n can be configured as a mobile BS capable of sustaining operation while moving from a first location to a second location. For example, a particular BS 104a may be coupled to an autonomous robot configured to navigate a particular communications environment 100. As such, the respective movements of one or more BSs 104a-n configured as mobile BSs may dynamically augment a range, coverage area, and/or general shape associated with a particular CCBS 102a associated with the one or more BSs 104a-n configured as mobile BSs.

In various embodiments, the communications environment 100 can support an unlimited number of BSs 104a-n. However, in various embodiments, the one or more CCBSs 102a-n associated with the communications environment 100 are configured to support a predetermined number of BSs 104a-n (e.g., forty-eight (48) BSs 104a-n) that may be in radio communication range in the same radio channel. Additionally, in various embodiments, one or more BSs (e.g., BSs 104a-c) associated with a particular CCBS 102a may be associated (e.g., assigned and/or pre-configured) with an initiator role which indicates that the one or more respective BSs associated with the initiator role can initiate the broadcast of a communication synchronization frame (CSF) across the particular CCBS 102a.

In one or more embodiments, the one or more BSs 104a-n are associated with a 64-bit identifier and/or a 16-bit address (e.g., the 16 least significant bits of a respective 64-bit identifier). In various contexts, the 16-bit address associated with a respective BS 104a is used as a send/receive address for one or more communications facilitated in the CCBS 102a. In various embodiments, the one or more BSs 104a-n are mains-powered (e.g., via an electrical grid associated with the communications environment 100). Additionally or alternatively, in one or more embodiments, the one or more BSs 104a-n may be powered via a portable battery system.

The one or more BSs 104a-n are configured to generate, transmit, and/or receive one or messages to be sent over one or more radio interfaces (e.g., configured as UWB message configured as a PPDU 402 transmitted with a 6.8 Mbps rate). For example, in some contexts, the one or more BSs 104a-n are configured to generate, transmit, and/or receive one or more BS messages, one or more almanac messages, one or more join messages, and/or one or more collision messages. Furthermore, the one or more BSs 104a-n are configured to transmit the one or more BS messages, the one or more almanac messages, the one or more join messages, and/or the one or more collision messages during a respective transmission time slot of a plurality of transmission time slots associated with a CSF.

Additionally, in various embodiments, the one or more BSs 104a-n are configured to transmit the one or more BS messages, one or more almanac messages, one or more join messages, and/or one or more collision messages to a broadcast address (e.g., during a respective transmission time slot of a CSF) that is common to the one or more BSs 104a-n such that each of the one or more BSs 104a-n receive the one or more BS messages, one or more almanac messages, one or more join messages, and/or one or more collision messages. Additionally or alternatively, in various embodiments, the one or more BSs 104a-n are configured to transmit one or more BS messages, one or more almanac messages, and/or one or more collision messages to a broadcast address (e.g., during a respective transmission time slot of a CSF) that is common to the one or more UEs 106a-n and/or the one or more trackers 108a-n such that the one or more UEs 106a-nand/or the one or more trackers 108a-n receive the one or more BS messages, one or more almanac messages, and/or one or more collision messages.

The CSF is configured to be broadcast across a particular CCBS 102a and is configured to synchronize one or more communications of the one or more BSs (e.g., BSs 104a-c) associated with the particular CCBS 102a. For example, in various embodiments, the CSF is configured based at least in part on a plurality of transmission time slots, where the plurality of transmission time slots comprises one or more BS slots, one or more almanac slots, one or more command slots, one or more command response slots, and/or one or more common slots. In various contexts, each of the one or more BSs 104a-n can be associated with (e.g., assigned to) a respective BS slot of the one or more BS slots associated with the CSF. As such, the CSF may be used to synchronize the communications of the one or more BSs 104a-n by ensuring that the one or more BSs 104a-n only transmit messages (e.g., BS messages) during the respective BS slot to which the one or more BSs 104a-n have been assigned. In various contexts, the one or more BSs 104a-n are configured determine their current position based on one or more messages received from other BSs 104a-n during the broadcast of the CSF (e.g., known as “location meshing”). For example, a respective BS 104a may determine its current location based on the data comprised in one or more messages received from one or more other BSs (e.g., BSs 104b-c) during the broadcast of the CSF.

In various embodiments, each of the messages generated by the one or more BSs 104a-n comprise a common message header (e.g., an SHR 404). The common message header may comprise one or more portions of data including, but not limited to, frame control data, message sequence data (e.g., a value indicating how many message were sent by the respective BS 104a), personal area network (PAN) identification data (e.g., a PAN identifier related to an associated CCBS), destination address data (e.g., a 16-bit identifier of the receiving apparatus, or a 16-bit value associated with a broadcast address), source address data (e.g., a 16-bit identifier of the transmitting apparatus), and/or message ID data. Additionally, in various embodiments, each of the messages generated by the one or more BSs 104a-n comprise a two byte checksum.

Additionally, in various embodiments, each of the messages generated by the one or more BSs 104a-n can be encrypted using one or more symmetric or asymmetric encryption techniques. For example, in various embodiments, the one or more BSs (e.g., BSs 104a-c) and/or the one or more UEs (e.g., UEs 106a-c) associated with a particular CCBS 102a may be configured to execute one or more symmetric encryption algorithms such as Advanced Encryption Standard (AES), Rivest Cipher (RC4), and/or Data Encryption Standard (DES). Additionally or alternatively, in various embodiments, the one or more BSs (e.g., the BSs 104a-c) and/or the one or more UEs (e.g., the UEs 106a-c) associated with a particular CCBS 102a may be configured to execute one or more asymmetric encryption algorithms such as Elliptic Curve Digital Signature Algorithm (ECDSA), and/or Rivest-Shamir-Adleman (RSA). Additionally or alternatively, in various embodiments, the one or more BSs (e.g., the BSs 104a-c) and/or the one or more UEs (e.g., UEs the 106a-c) associated with a particular CCBS 102a may be configured to execute one or more hashing algorithms such as Message Digest Algorithm (MD5), Secure Hashing Algorithm (SHA-1, SHA-2, SHA-3), and/or Cyclical Reduction Check (CRC32).

The one or more BSs 104a-n are configured to generate, transmit, and/or receive one or more BS messages associated with a current configuration of the one or more respective BSs 104a-n. For example, a BS 104a may generate one or more BS messages based at least in part on one or more BS message parameters associated with one or more portions of data related to the current configuration of the BS 104a. The one or more BS message parameters may comprise at least one of a BS message identifier, a BS slot number (e.g., a BS slot number assigned to the BS 104a), a CSF number (e.g., a value associated with a number of CSFs that have been broadcast in the CCBS 102a and is configured to be incremented by a predefined value (e.g., a value of 1) each time a CSF is broadcast), a communication session identifier (e.g., a random number generated by a BS 104a associated with an initiator role), a clock level (e.g., a current clock level associated with the BS 104a), one or more flag bits (e.g., indicating a reserved common transmission slot, or indicating that almanac data associated with the BS 104a has changed and is associated with the current CSF), one or more portions of reserved BS slot data (e.g., bit values indicating reserved BS slots associated with the CSF), a BS message send time, one or more portions of BS measurement data (e.g., a 16-bit ID of the BS 104a and corresponding transmission reception quality), a BS message processing time (e.g., a measure of time from the reception of a last BS message (e.g., from a different BS) to a send time of a BS message being currently transmitted by the BS 104a), a BS message signal level, and/or a BS message signal boost level. The BS 104a may, in some contexts, transmit a BS message using a 10 Hz frequency during a transmission time slot associated with the CSF that has been assigned to the BS 104a.

The one or more BSs 104a-n are configured to generate, transmit, and/or receive one or more almanac messages associated with a current location of the of the one or more respective BSs 104a-n. For example, a BS 104a may generate one or more almanac messages based at least in part on one or more almanac message parameters associated with one or more portions of data related to the current location of the BS 104a. The one or more almanac message parameters may comprise at least one of an almanac message identifier, a BS slot number (e.g., a BS slot number assigned to the BS 104a), a BS identifier (e.g., a 64-bit BS ID), a hardware version number, a software version number, a software checksum (e.g., a CRC32), a BS latitude (e.g., a degree of latitude associated with the BS 104a, scaled by 2(31/180)), a BS longitude (e.g., a degree of longitude associated with the BS 104a, scaled by 2(31/180)), a BS altitude (e.g., an altitude in WGS84 standard format), a BS position uncertainty, a CCBS altitude (e.g., an altitude associated with a level/floor associated with the CCBS 102a associated with the BS 104a), a CCBS floor number (e.g., a value representing a level/floor number associated with the CCBS 102a associated with the BS 104a), and/or one or more portions of neighbor CCBS data (e.g., data related to a CCBS that is adjacent, above, or below the CCBS 102a associated with the BS 104a including a respective predefined set of radio parameters).

In various embodiments, each of the one or more BSs 104a-n are configured to transmit a respective almanac message during a predefined, recurring CSF. For example, in various contexts, the one or more BSs 104a-n are configured to transmit a respective almanac message every sixteenth CSF. In this example, a respective BS 104a may determine when to transmit the respective almanac message based on an almanac message transmission function that takes as input the CSF number (e.g., the value associated with the number of CSFs that have been broadcast in a respective CCBS 102a), and the BS slot number associated with the BS 104a. In various embodiments the almanac message transmission function can be defined as:
sfNumber % 16==slotNumber % 16

where sfNumber is the CSF number and slotNumber is the BS slot number associated with the BS 104a. When the BS 104a determines that sfNumber modulo 16 is equal to slotNumber modulo 16, the BS 104a will cause transmission of an almanac message associated with the current location of the BS 104a. To determine which almanac slot of the one or more almanac slots of the CSF the BS 104a will use to transmit the respective almanac message, the BS 104a may use the following function:
floor (slotNumber/16)

Additionally, the BS 104a may set an almanac bit (e.g., a flag bit) in a respective BS message to indicate that an almanac message and/or almanac message data is included in a respective CSF. As such, one or more UEs 106a-n and/or one or more trackers 108a-n which require one or more portions of almanac data (e.g., for positioning purposes) can be configured to receive the one or more portions of almanac data via the transmission of the respective almanac message during the almanac slot of the respective CSF.

In various embodiments, the one or more almanac messages may comprise one or more portions of data related to one or more location estimates associated with each of the one or more respective BSs (e.g., BSs 104a-c) associated with a respective CCBS 102a. As such, in various embodiments, the one or more respective BSs (e.g., the BSs 104a-c) are configured to receive and/or generate a BS “map” describing the relative locations of the one or more respective BSs (e.g., the BSs 104a-n) associated with the respective CCBS 102a. In one or more embodiments, the one or more almanac messages and/or the BS map comprise one or more portions of data related to one or more BS slots that have been allocated to (e.g., assigned to) one or more respective BSs (e.g., the BSs 104a-c) associated with the respective CCBS 102a. In various contexts, the one or more BSs (e.g., the BSs 104a-c) may be configured to transmit a BS map as part of a BS message. Additionally or alternatively, the one or more BSs (e.g., the BSs 104a-c) may be configured to transmit the BS map to one or more requesting BSs that have requested to join the CSF associated with the respective CCBS 102a.

In one or more embodiments, a BS map is associated with a set of 48 bits or flags which indicate which of the 48 available BS slots of a respective CCBS (e.g., CCBS 102a) are currently reserved from the point of view of a respective BS 104a transmitting a respective BS message. By combining BS maps (e.g., via a function executing a “binary OR” of the BS maps) a receiving BS (e.g., BS 104b) can form a BS map representative of all the reserved BS slots associated with the respective CCBS (e.g., CCBS 102a) and, furthermore, in the areas that one or more or other currently detected BSs may receive one or more transmissions (e.g., an area where a CCBS 102a and a CCBS 102b may overlap). In this manner, a respective communications system (e.g., associated with one or more CCBSs 102a-n) can ensure that free (e.g., available) BS slots are not colliding for the one or more BSs 104a-n in a current communications environment 100.

The one or more BSs 104a-n are configured to generate, transmit, and/or receive one or more join messages associated with a request to join a respective CSF at a requested BS slot. For example, a BS 104a may generate one or more join messages based at least in part on one or more join message parameters associated with one or more portions of data related to the request to join the respective CSF. The one or more join message parameters may comprise at least one of a join message identifier, a BS identifier (e.g., a 64-bit BS ID), a hardware version number, a software version number, a software checksum, and/or the requested BS slot. In various embodiments, the requested BS slot can be a randomly selected slot from one or more observed free BS slots associated with the CSF associated with a respective CCBS.

In various contexts, a BS (e.g., BS 104b) may determine if the BS has been allocated (e.g., assigned) a respective BS slot of the one or more BS slots of the CSF. If the BS (e.g., the BS 104b) determines that the (e.g., the BS 104b) has not been allocated (e.g., assigned) a respective BS slot of the one or more BS slots of the CSF, the BS (e.g., the BS 104b) may generate and transmit a join message as part of a CSF joining procedure. In various embodiments, the BS (e.g., the BS 104b) can transmit the join message during a command slot associated with the CSF. In various contexts, the BS (e.g., the BS 104b) can transmit the join message to a target BS (e.g., BS 104a), where the target BS is a BS that has been included in a highest number of CSFs relative to the one or more other BSs associated with the respective CCBS. In various contexts, if one or more BSs associated with the respective CCBS have been in a same number (e.g., a same highest number) of CSFs, a target BS can be chosen from the one or more BSs at random. Additionally or alternatively, the target BS can be determined based on one or more measurements associated with a respective set of radio channel parameters associated with the target BS (e.g., a radio channel quality measurement, a signal strength measurement, and/or a distance measurement).

In various embodiments, the BS (e.g., the BS 104b) may, as part of a CSF joining procedure, wait a predetermined amount of CSFs (e.g., predetermined via a function such as rand(5, 50)) before transmitting the join message, during which the BS (e.g., the BS 104b) may (i) count how many BS messages have been received from each BS slot of the one or more BS slots associated with the CSF, (ii) determine if a prior BS slot associated with the BS (e.g., the BS 104b) is known and/or free, and/or (iii) if no transmission are received during the predetermined wait time and the BS (e.g., the BS 104b) is associated with an initiator role, initiate a new CSF with the prior BS slot associated with the BS (e.g., the BS 104b) or BS slot 0 if the prior BS slot is unknown. In various contexts, if the BS (e.g., the BS 104b) determines that the prior BS slot associated with the BS (e.g., the BS 104b) is known and free, the BS (e.g., the BS 104b) may use the prior BS slot without first transmitting a join message requesting to be assigned to the prior BS slot.

The one or more BSs 104a-n are configured to generate, transmit, and/or receive one or more join response messages associated with a determination associated with a join request by a BS to join a respective CSF at a requested BS slot. For example, a target BS (e.g., BS 104a) may generate, in response to receiving a join message from a requesting BS (e.g., BS 104b), one or more join response messages based at least in part on one or more join response message parameters. In various embodiments, the one or more join response message parameters comprise at least one of a join response message identifier, a BS identifier (e.g., a 64-bit BS ID), the requested BS slot, and/or a join status indication. In various contexts, the join status indication may indicate if the requesting BS is able to join the respective CSF at the requested BS slot or if a joining error has occurred. Joining errors may include, but are not limited to, a determination that a requested BS slot is already reserved by a different BS, a BS with a same identifier is already associated with the respective CCBS (e.g., the CCBS 102a), and/or a determination that the requesting BS (e.g., the BS 104b) is associated with incompatible software and/or hardware such that the requesting BS (e.g., the BS 104b) cannot successfully communicate with the one or more other components associated with the respective CCBS (e.g., one or more BSs 104a-c, UEs 106a-c, and/or trackers 108a-c associated with the respective CCBS 102a).

As shown in FIG. 1, the communications environment 100 may comprise one or more UEs 106a-n that communicate with one or more BSs 104a-n associated with the same CCBS (e.g., CCBS 102a). In some embodiments, the one or more UEs 106a-n may be a mobile station, and such a mobile station may comprise, by way of example, a mobile telephone, a computer, or any other type of communication device. The terms “user equipment (UE),” “user device,” “computing device,” or “apparatus” as used herein are therefore intended to be construed broadly, so as to encompass a variety of different types of mobile stations, subscriber stations or, more generally, communication devices, including examples such as a combination of a data card inserted in a laptop or other equipment.

The one or more UEs 106a-n may also refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. A UE 106a may also be an IoT device having the capability to operate in an IoT network, which is a scenario in which apparatuses are provided with the ability to transfer data over a network without requiring human-to-human or human-to-computer interaction. The UE 106a (or in some embodiments a layer 3 relay node) is configured to perform one or more user device functionalities. The UE 106a may also be called a subscriber unit, mobile station, remote terminal, access terminal, and/or user terminal.

Furthermore, in one or more embodiments, one or more UEs 106a-n associated with the communications environment 100 can be integrated with, embodied by, and/or otherwise associated with an autonomous device such as an autonomous robot, autonomous vehicle, autonomous drone, and/or the like that may be configured to autonomously and/or semi-autonomously navigate the communications environment 100. As such, one or more UEs (e.g., UEs 106a-c) associated with a respective CCBS 102a are configured to determine their current location based at least in part on one or more portions of data comprised in one or more messages (e.g., one or more BS messages and/or one or more almanac messages) transmitted by the one or more BSs (e.g., BSs 104a-c) associated with the respective CCBS 102a during a broadcast of a CSF. Additionally or alternatively, in various embodiments, one or more UEs (e.g., UEs 106a-c) may be configured to utilized one or more RTT and/or multi-RTT positioning techniques facilitated by the one or more BSs (e.g., BSs 104a-c) of the respective CCBS 102a. As such, in one or more embodiments, the one or more UEs 106a-n are configured to both receive data from the one or more BSs 104a-n as well as transmit data to the one or more BSs 104a-n (e.g., transmit data in response and/or acknowledgement of receipt of positioning data from the one or more BSs 104a-n during an RTT positing procedure).

The one or more trackers 108a-n associated with the one or more CCBSs 102a-n of the communications environment 100 can integrate, embody, or be embodied by one or more type of apparatuses computing devices, mobile devices, and/or autonomous devices such as an autonomous robot, autonomous vehicle, autonomous drone, and/or the like that may be configured to autonomously and/or semi-autonomously navigate the communications environment 100. In various embodiments, the one or more trackers 108a-n may be exclusively downlink-only devices configured only to receive one or more transmissions from one or more BSs 104a-n associated with a respective CCBS 102a.

The one or more trackers (e.g., trackers 108a-c) associated with a respective CCBS 102a are configured to determine their current location based at least in part on one or more portions of data comprised in one or more messages (e.g., one or more BS messages and/or one or more almanac messages) transmitted by the one or more BSs (e.g., BSs 104a-c) associated with the respective CCBS 102a during a broadcast of a CSF. For example, the one or more trackers (e.g., the trackers 108a-c) can calculate their position based at least in part on one or more portions of message transmission timing data comprised in one or more BS messages and/or one or more portions of BS location data comprised in one or more almanac messages transmitted by the one or more BSs (e.g., the BSs 104a-c) associated with the respective CCBS 102a during the broadcast of the CSF. In various embodiments, assuming that the one or more trackers 108a-n have already received the necessary almanac data (e.g., BS location data), the one or more trackers 108a-n need only receive one to two CSFs in order to update the current position of the one or more trackers 108a-n.

As described herein, the configuration of the one or more trackers 108a-n enables the one or more trackers 108a-n to determine the respective positions of the one or more trackers 108a-n without acknowledging (e.g., transmitting a response) to the one or more BSs 104a-n that the one or more trackers 108a-n have received the one or more BS messages and/or almanac messages. As such, embodiments of the present disclosure provide the technological benefit of providing high-precision positioning services to an unlimited number of trackers 108a-n as the one or more trackers 108a-n are configured to exclusively receive transmissions from the one or more BSs 104a-n associated with one or more CCBSs 102a-n and compute the positions of the respective trackers 108a-n via processing circuitries embodied by the one or more respective trackers 108a-n. This reduction in overhead provides the technological benefit of reducing both the computational resources and energy requirements of the one or more components associated with the communications environment 100. Furthermore, as the one or more trackers 108a-n do not transmit any radio messages, the one or more trackers 108a-n are not visible over radio infrastructure, thus reducing radio noise and/or interference for the communications environment 100 while offering simultaneous privacy and security benefits for the one or more trackers 108a-n.

In various embodiments, the one or more UEs 106a-n and/or the one or more trackers 108a-n associated with the communications environment 100 are configured to receive one or more simultaneous transmissions from two or more respective CCBSs 102a-n. Furthermore, in various contexts, the one or more UEs 106a-n and/or the one or more trackers 108a-n are configured to determine a preferred CCBS of the two or more respective CCBSs 102a-n based at least in part on one or more measurements associated with a predefined set of radio channel parameters associated with the two or more respective CCBSs 102a-n.

For example, as shown in FIG. 1, if a UE (e.g., UE 106c) and/or a tracker (e.g., tracker 108c) are proximate to the coverage areas associated with a first CCBS (e.g., CCBS 102a) and a second CCBS (e.g., CCBS 102n) such that the UE (e.g., the UE 106c) and/or the tracker (e.g., the tracker 108c) are simultaneously receiving transmissions (e.g., BS messages) from the first CCBS (e.g., the CCBS 102a) and the second CCBS (e.g., the CCBS 102n), the UE (e.g., the UE 106c) and/or the tracker (e.g., the tracker 108c) can take one or more measurements associated with the respective sets of radio channel parameters associated with the first CCBS and the second CCBS. In various embodiments, the one or more measurements associated with the set(s) of radio channel parameters comprise at least one of a radio channel quality measurement, a signal strength measurement, and/or a distance measurement from a nearest BS (e.g., BS 104c) associated with the one or more respective transmissions (e.g., BS messages) from the first CCBS (e.g., the CCBS 102a) and the second CCBS (e.g., the CCBS 102n) from communication clusters of BSs. Based on the one or more measurements, the UE (e.g., the UE 106c) and/or the tracker (e.g., the tracker 108c) can determine a preferred CCBS of the first CCBS (e.g., the CCBS 102a) and the second CCBS (e.g., the CCBS 102n).

In various contexts, a UE (e.g., UE 106c) and/or a tracker (e.g., tracker 108c) may need to determine a preferred CCBS as part of a handover or transition process. As a non-limiting example, the UE (e.g., the UE 106c) and/or the tracker (e.g., the tracker 108c) may be navigating the communications environment 100 such that the UE and/or the tracker are traveling from a first location associated with a first CCBS (e.g., CCBS 102a) to a second location associated with a second CCBS (e.g., CCBS 102n). For example, the UE (e.g., the UE 106c) and/or the tracker (e.g., the tracker 108c) may be navigating from a first floor of a building associated with the first CCBS (e.g., CCBS 102a) to a second floor of the building that is associated with the second CCBS (e.g., CCBS 102n).

As another example, the UE (e.g., the UE 106c) and/or the tracker (e.g., the tracker 108c) may be navigating from a first area on a particular floor of a building associated with the first CCBS (e.g., CCBS 102a) to a second area of the same floor of the building that is associated with the second CCBS (e.g., CCBS 102n). As such, the UE (e.g., the UE 106c) and/or the tracker (e.g., the tracker 108c) may need to determine a preferred CCBS (e.g., a CCBS with stronger, clearer radio signals) of the first CCBS (e.g., CCBS 102a) and the second CCBS (e.g., CCBS 102n) as the UE and/or the tracker are navigating the communications environment 100 associated with the first and the second CCBS.

Furthermore, in various contexts, the UE (e.g., the UE 106c) and/or the tracker (e.g., the tracker 108c) may periodically take one or more measurements associated with the respective sets of radio channel parameters associated with one or more neighboring CCBSs to determine if a particular neighboring CCBS of the one or more neighboring CCBSs is providing better radio conditions for positioning the UE (e.g., the UE 106c) and/or the tracker (e.g., the tracker 108c).

It will be appreciated that while the non-limiting examples provided herein above are related to determining a preferred CCBS between two respective CCBSs, the UE (e.g., the UE 106c) and/or the tracker (e.g., the tracker 108c) are configured to determine a preferred CCBS from a plurality (e.g., three or more) of CCBSs.

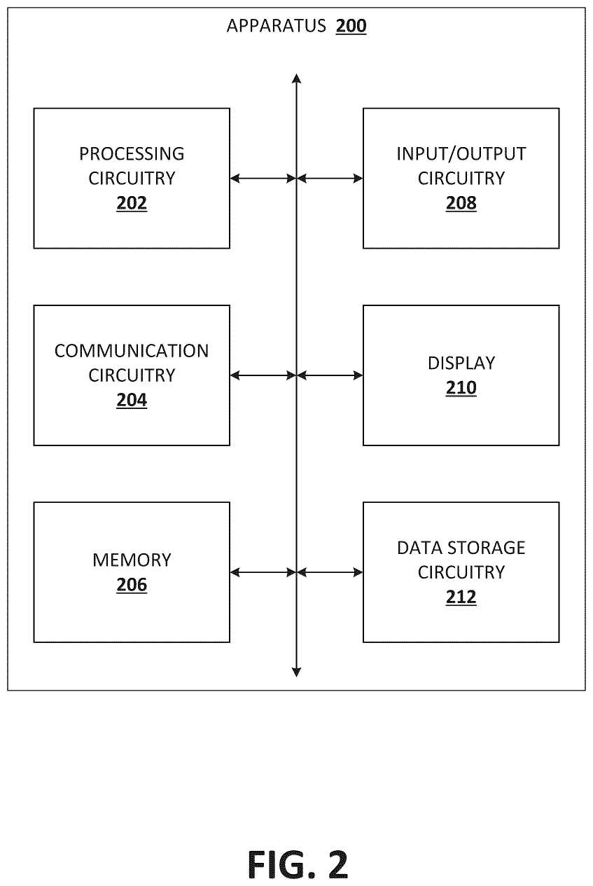

FIG. 2 illustrates an example of an apparatus 200 that may be configured to function as, or may be embodied by, a network entity associated with a communications environment 100 including, but not limited to, a BS 104a, a UE 106a, a tracker 108a, an autonomous device (e.g., autonomous robot, autonomous vehicle, autonomous drone, etc.), an access node, and/or any computing device configured to execute the one or more methods described herein. As shown in FIG. 2, the apparatus 200 includes, is associated with, or is in communication with processing circuitry 202, communication circuitry 204, memory 206, input/output circuitry 208, display 210. and/or data storage circuitry 212. The processing circuitry 202 may be in communication with the memory via a bus for passing information among components of the apparatus 200. The apparatus 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 202 may be embodied in a number of different ways. For example, the processing circuitry 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 202 may be configured to execute instructions stored in the memory 206 or otherwise accessible to the processing circuitry 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC. FPGA or the like, the processing circuitry may be specifically configured hardware for conducting the operations described herein. Alternatively, as another example, when the processing circuitry 202 is embodied as an executor of instructions, the instructions may specifically configure the processor to perform the algorithms and/or operations described herein when the instructions are executed. However, in some cases, the processing circuitry 202 may be a processor of a specific device (e.g., an image or video processing system) configured to employ an embodiment of the present disclosure by further configuration of the processing circuitry by instructions for performing the algorithms and/or operations described herein. The processing circuitry 202 may include, among other things, a clock, an arithmetic logic unit (ALU) and logic gates configured to support operation of the processing circuitry.

The communication circuitry 204 may be any means such as a device or circuitry embodied in either hardware or a combination of hardware and software that is configured to receive and/or transmit data from/to a network and/or any other device (e.g., a particular UE 106a, BS 104a, and/or the like) or module in communication with the apparatus 200. In this regard, the communication circuitry 204 may include, for example, a network interface for enabling communications with a wired or wireless communication network. For example, the communications circuitry 204 may include one or more circuitries, network interface cards, antennae, buses, switches, routers, modems, and supporting hardware and/or software, or any other device suitable for enabling communications via a network. Furthermore, the communication circuitry 204 may include, for example, an antenna (or multiple antennas) and supporting hardware and/or software for enabling communications with a wireless communication network.

Additionally, the communication circuitry 204 can embody and/or integrate with one or more RF and/or wireless transceivers, where each wireless transceiver includes a transmitter to transmit signals and a receiver to receive signals. The one or more RF and/or wireless transceivers can be configured for facilitating communication on a 4G/LTE network, a 5G network, UWB network, and/or the like. Additionally, the one or more RF and/or wireless transceivers can be configured for facilitating communication on various respective communication networks. The one or more RF and/or wireless transceivers receive signals or data and/or transmit or send signals and/or data. In various embodiments, processing circuitry 202 can control the antenna(s) and/or the one or more RF and/or wireless transceivers to receive, send, broadcast, or transmit signals and/or data. Additionally or alternatively, the communication circuitry 204 may include the circuitry for interacting with the antenna(s) and/or the one or more RF and/or wireless transceivers to cause transmission of signals via the antenna(s) or to handle receipt of signals received via the antenna(s). Additionally or alternatively, in some environments, the communication circuitry 204 may support wired communication. As such, for example, the communication circuitry 204 may include a communication modem and/or other hardware/software for supporting communication via cable, digital subscriber line (DSL), universal serial bus (USB) or other mechanisms.

The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processing circuitry 202. Additionally or alternatively, the memory 206 could be configured to store instructions for execution by the processing circuitry 202.

In some embodiments, the apparatus 200 includes input/output circuitry 208 that may, in turn, be in communication with the processing circuitry 202 to provide output to a user and, in some embodiments, to receive an indication of a user input. The input/output circuitry 208 may comprise an interface or the like. In some embodiments, the input/output circuitry 208 may include a keyboard, a mouse, a joystick, a touch screen, touch areas, soft keys, a microphone, a speaker, or other input/output mechanisms. The processing circuitry 202 and/or input/output circuitry 208 may be configured to control one or more functions of one or more user interface elements through computer program instructions (e.g., software and/or firmware) stored on a memory accessible to the processor (e.g., memory 206).

In some embodiments, the apparatus 200 includes the display 210 that may, in turn, be in communication with the processing circuitry 202 to display user interfaces (such as, but not limited to, display of a call and/or an application). In some embodiments of the present disclosure, the display 210 may include a liquid crystal display (LCD), a light-emitting diode (LED) display, a plasma (PDP) display, a quantum dot (QLED) display, and/or the like.

In some embodiments, the apparatus 200 includes the data storage circuitry 212 which comprises hardware, software, firmware, and/or a combination thereof, that supports functionality for generating, storing, and/or maintaining one or more data objects associated with the apparatus 200 and/or one or more communication clusters of BSs (e.g., CCBSs 102a-n). For example, in some embodiments, the data storage circuitry 212 includes hardware, software, firmware, and/or a combination thereof, that stores data related to one or more UEs, BSs, and/or CSFs. In some embodiments, the data storage circuitry 212 can be integrated with, or embodied by, a cloud-based data storage system. In some embodiments, the data storage circuitry 212 includes a separate processor, specially configured field programmable gate array (FPGA), or a specially programmed application specific integrated circuit (ASIC).

FIG. 3 illustrates relative frequency ranges and energy outputs associated with various respective radio frequency transmissions in accordance with one or more example embodiments of the present disclosure. As described herein, a signal pulse associated with the UWB transmission 306 occupies a wide frequency band and the rising edge of the signal pulse is very steep and is therefore easy to detect in a noisy radio environment which allows an apparatus (e.g., a UE, BS, IoT device, and/or the like) to measure an arrival time of the respective signal accurately. Furthermore, the signal pulses associated UWB transmissions have a short duration relative to other transmission types (e.g., the spread spectrum transmission 302 and/or the narrowband transmission 304) and, in many contexts, typically take no more than two nanoseconds.

FIG. 4 illustrates an example UWB communication transmission frame configured in accordance with one or more example embodiments of the present disclosure. As described herein, UWB transmissions, in many contexts, are configured in a physical layer convergence procedure (PLCP) protocol data unit (PPDU) 402. The PPDU 402 begins with a synchronization header (SHR) 404 and is followed by a PLCP service data unit (PSDU) 406. As shown in FIG. 4, the SHR 404 comprises a plurality of bits related to a preamble 408 and a start of the frame delimiter (SFD) 410. The SHR 404 is followed by a PHY header (PHR) 412 that defines a length and data rate of the data payload of the PPDU 402. The PSDU 406 comprises a data field 414 associated with the data payload of the PPDU 402.

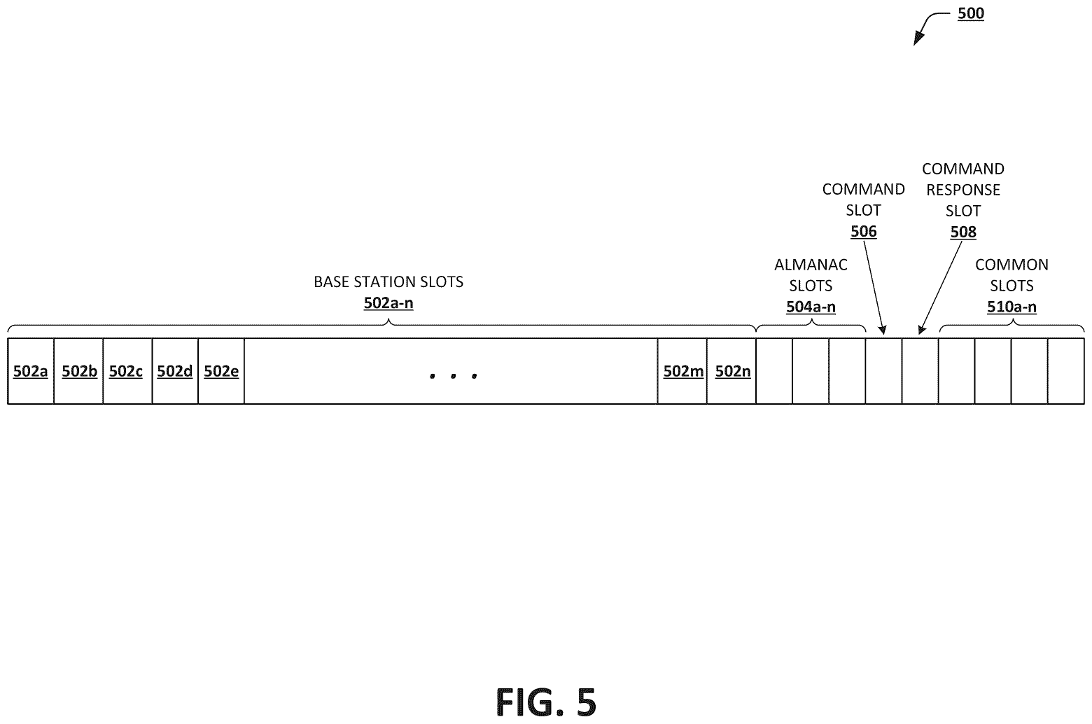

FIG. 5 illustrates an example CSF 500 configured to be broadcast across a respective CCBS (e.g., CCBS 102a) in accordance with one or more example embodiments of the present disclosure. As described herein, the CSF 500 is configured to is configured to synchronize one or more communications of the one or more BSs (e.g., BSs 104a-c) associated with the respective CCBS 102a. For example, in various embodiments, the CSF 500 is configured based at least in part on a plurality of transmission time slots, where the plurality of transmission time slots comprises one or more BS slots 502a-n, one or more almanac slots 504a-n, one or more command slots (e.g., command slot 506), one or more command response slots (e.g., command response slot 508), and/or one or more common slots 510a-n.

In various contexts, each of the one or more BSs 104a-n can be associated with (e.g., assigned to) a respective BS slot of the one or more BS slots 502a-n associated with the CSF 500. As such, the CSF 500 may be used to synchronize the communications of the one or more BSs 104a-n by ensuring that the one or more BSs 104a-n only transmit messages (e.g., BS messages) during the respective BS slot (e.g., BS slot 502a) to which the one or more BSs 104a-n have been assigned. In various contexts, the one or more BSs 104a-n are configured determine their current position based on one or more messages received from other BSs 104a-n during the broadcast of the CSF 500 (e.g., known as “location meshing”). For example, a respective BS 104a may determine its current location based on the data comprised in one or more messages received from one or more other BSs 104b-n during the broadcast of the CSF 500.

In various embodiments, a respective CSF 500 has a broadcast duration of 100milliseconds and, as such, allow for apparatus positioning at a 10 Hz rate. As illustrated in FIG. 5, a respective CSF may have a predetermined structure comprised of one or more transmission time slots including one or more BS slots 502a-n, one or more almanac slots 504a-n, one or more command slots (e.g., command slot 506), one or more command response slots (e.g., command response slot 508), and/or one or more common slots 510a-n. For example, in various embodiments, a respective CSF 500 may have forty-eight (48) BS slots 502a-n, three (3) almanac slots 504a-n, one (1) command slot 506, one (1) command response slot 508, and/or four (4) common slots 510a-n. In various embodiments, each of the one or more transmission time slots have respective transmission duration of 1 millisecond.

As described herein, one or more BSs (e.g., BSs 104a-c) can be allocated (e.g., assigned) a respective BS slot of the one or more BS slots 502a-n associated with a CSF 500 associated with a respective CCBS 102a. In various contexts, the one or more BSs (e.g., the BSs 104a-c) may be assigned a respective BS slot of the one or more BS slots 502a-n based on an initial configuration procedure executed as the respective CCBS 102a is being configured. Additionally or alternatively, one or more BSs (e.g., BSs 104a-n) may join an existing CCBS (e.g., CCBS 102a) as a result of a CSF joining procedure in which the one or more BSs generate a request to join a CSF associated with the existing CCBS at a requested BS slot of the one or more BS slots 502a-n.

As described herein, in various embodiments, one or more BSs (e.g., BSs 104a-c) associated with a particular CCBS 102a may be associated (e.g., assigned and/or pre-configured) with an initiator role which indicates that the one or more respective BSs (e.g., the BSs 104a-c) associated with the initiator role can initiate the broadcast of a CSF 500 across the particular CCBS 102a. As such, a BS 104a associated with the initiator role may be labeled as an initiator BS and start the CSF 500. In this regard, the BS 104a labeled as the initiator BS sets the transmission timing for the CSF 500 which synchronizes the other BSs (e.g., BSs 104b-c) associated with the respective CCBS 102a. In various embodiments, there may be only one BS operating as an initiator BS in a respective CCBS 102a.

The BS 104a labeled as the initiator BS sets a clock level value associated with the BS 104a to a predefined initial clock level value (e.g., an initial clock level value of 0) and indicates the clock level to the other BSs associated with the respective CCBS 102a (e.g., BSs 104b-c) via a respective BS message (e.g., a first BS message of one or more BS messages associated with a first CSF initiated by the BS 104a labeled as the initiator BS). The other BSs associated with the respective CCBS 102a (e.g., BSs 104b-c) determine a value of a smallest received clock level from the one or more BS messages associated with a respective CSF (e.g., the first CSF), increment the value of the smallest received clock level by a predefined amount (e.g., a value of 1), and set a clock level value associated with the other respective BSs (e.g., BSs 104b-c) based on the incremented value. In various embodiments, one or more BSs associated with an initiator role but are not currently the initiator BS may be given priority to set a next-lowest clock level (e.g., a clock level value of 1) relative to the BS 104a labeled as the initiator BS.

For example, a second BS (e.g., the BS 104b) may determine a value of a smallest received clock level from the first BS (e.g., the BS 104a), increment the value of the smallest received clock level by a predefined amount (e.g., a value of 1), and set a clock level value associated with the second BS (e.g., the BS 104b) based on the incremented value. Subsequently, a third BS (e.g., the BS 104c) may determine a value of a smallest received clock level from the second BS (e.g., the BS 104b), increment the value of the smallest received clock level by a predefined amount (e.g., a value of 1), and set a clock level value associated with the third BS (e.g., the BS 104c) based on the incremented value. In this regard, the respective BSs (e.g., BSs 104b-c) can store the respective incremented clock level values as a respective clock level and indicate the respective clock level in one or more subsequent BS messages transmitted by the respective BSs (e.g., BSs 104b-c).

In various embodiments, if a BS (e.g., BS 104c) detects a clock level value associated with a respective BS message has incremented to a value greater a predetermined clock level threshold (e.g., a value of 255), the BS may stop broadcasting in the respective CCBS (e.g., the CCBS 102a). This will stop communications in the respective CCBS in the event that the BS 104a labeled as the initiator BS has ceased to send BS messages for a relatively long duration of time (e.g., 25 seconds). Furthermore, this also limits a maximum size of a particular CCBS (e.g., CCBS 102a). For example, a predetermined clock level threshold associated with a value of 255 will limit the size of the particular CCBS (e.g., CCBS 102a) to 255 hops (e.g., transmissions between respective network elements such as BSs) thus reducing a maximum coverage area associated with the particular CCBS (e.g., a maximum linear distance of 10 km from the BS 104a labeled as the initiator BS).

Furthermore, if a second BS (e.g., BS 104b) associated with an initiator role detects that a clock level value associated with a respective BS message exceeds a preselected value (e.g., a clock level value determined via a function such as rand(5, 20)), the second BS (e.g., the BS 104a) may determine that a first BS (e.g., BS 104a) labeled as an initiator BS has malfunctioned and/or otherwise ceased to transmit BS messages and has therefore ceased to correctly synchronize the communications of the respective CCBS (e.g., CCBS 102a). As such, the second BS (e.g., the BS 104b) may take on the label of the initiator BS, indicate that the respective clock level value associated with the second BS (e.g., the BS 104b) is the predefined initial clock level value (e.g., the initial clock level value of 0), and cause initiation and/or broadcast of one or more subsequent CSF(s) 500 across the respective CCBS (e.g., the CCBS 102a). For example, in a scenario in which an initiator BS (e.g., BS 104a) associated with a respective CCBS (e.g., CCBS 102a) has ceased to send BS messages it is given that there would no longer be a BS sending messages indicating a clock level of zero. As described herein, each BS takes a lowest received clock level and increments it by a predetermined value (e.g., a value of 1). This incrementation will still take place for each CSF transmitted without an initiator BS such that the respective clock level of each BS is incremented until the predetermined clock level threshold is reached for each BS (e.g., a clock level threshold value of 255), after which the CSF would be terminated. If there another BS associated with an initiator role is available during such a scenario, that BS would take on initiator role before the clock level threshold is exceed (e.g., after five CSF transmissions). In this way, the components of a respective CCBS can continue to operate uninterrupted in the event that an initiator BS fails and/or ceases to transmit BS messages.

Additionally or alternatively, if a first BS (e.g., the BS 104b) operating as an initiator BS detects that a second BS (e.g., a BS 104c) is associated with a clock level value that equals the predefined initial clock level value (e.g., the initial clock level value of 0), the first BS (e.g., the BS 104b) may determine whether to stop operating as the initiator BS. In various embodiments, the first BS (e.g., the BS 104b) operating as the initiator BS can determine to stop operating as the initiator BS based at least in part on a determination that a 16-bit address associated with the first BS (e.g., the BS 104b) is bigger than a 16-bit address associated with the second BS (e.g., the BS 104c).

### EXAMPLE METHODS OF THE PRESENT DISCLOSURE

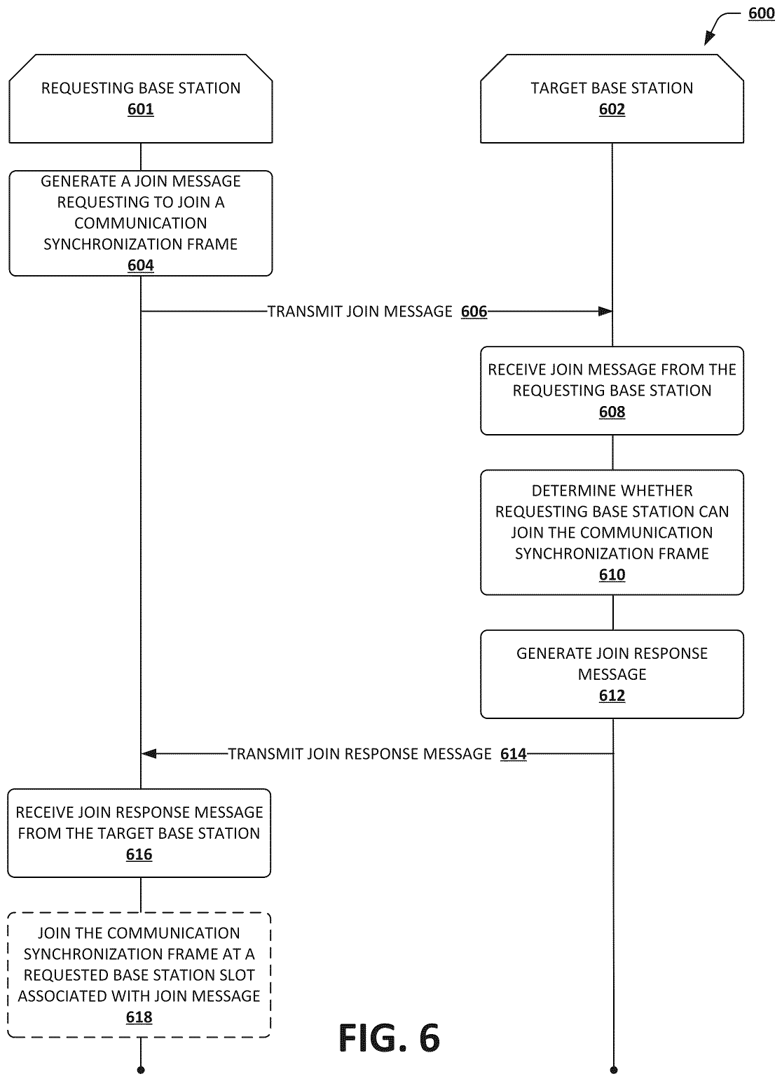

FIG. 6 illustrates a flowchart depicting a method 600 associated with a communication synchronization frame (CSF) joining procedure in accordance with one or more example embodiments of the present disclosure. The method 600 can be implemented, for example, by one or more components of an apparatus 200. In various embodiments the apparatus 200 can be embodied can be embodied by a networking element (e.g., a base station (BS) 104a). In various other embodiments, the apparatus 200 can be embodied by user equipment (UE) 106a. Additionally or alternatively, the apparatus 200 can be embodied by any other particular computing device (e.g., autonomous robot, IoT device, smartphone, laptop, tablet computer, networking device, etc.) associated with a particular communications network. It will be appreciated that the apparatus 200 may be configured to perform the method 600 with the reference to the components of the apparatus 200 again being provided by way of example but not of limitation. As such, the apparatus 200 includes means, such as the processing circuitry 202, at least one processor, communication circuitry 204, at least one memory 206, data storage circuitry 212, and/or the like, configured to perform the various operations associated with the method 600.

The method 600 begins at operation 604 in which an apparatus 200 associated with a requesting BS 601 is configured to generate a join message requesting to join a CSF 500 associated with a respective communication cluster of base stations (CCBS) (e.g., CCBS 102a). For example, as described herein, a requesting BS 601 may generate one or more join messages based at least in part on one or more join message parameters associated with one or more portions of data related to the request to join the respective CSF 500. The one or more join message parameters may comprise at least one of a join message identifier, a BS identifier (e.g., a 64-bit BS ID), a hardware version number, a software version number, a software checksum, and/or a requested BS slot (e.g., a requested BS slot of the one or more BS slots 502a-n). In various embodiments, the requested BS slot can be a randomly selected slot from one or more observed free BS slots associated with the CSF 500 associated with the respective CCBS (e.g., the CCBS 102a).

At operation 606, the apparatus 200 associated with the requesting BS 601 is configured to transmit the join message to a target BS 602. For example, in various embodiments, the requesting BS 601 can transmit the join message during a command slot 506 associated with the CSF 500. In various contexts, the requesting BS 601 can transmit the join message to the target BS 602, where the target BS 602 is a BS that has been included in a highest number of CSFs 500 relative to the one or more other BSs associated with the respective CCBS (e.g., the CCBS 102a). In various contexts, if one or more BSs associated with the respective CCBS have been in a same number (e.g., a same highest number) of CSFs, the target BS 602 can be chosen from the one or more BSs at random. Additionally or alternatively, the target BS 602 can be determined based on one or more measurements associated with a respective set of radio channel parameters associated with the target BS 602 (e.g., a radio channel quality measurement, a signal strength measurement, and/or a distance measurement).

At operation 608, an apparatus 200 associated with a target BS 602 is configured to receive the join message from the requesting BS 601. For example, a target BS 602 of the one or more BSs associated with the same respective CCBS (e.g., CCBS 102a) as the requesting BS 601 can receive the join message from the requesting BS 601.

At operation 610, the apparatus 200 associated with the target BS 602 is configured to determine whether the requesting BS 601 can join the CSF 500 at the requested BS slot. In various contexts, the join status indication may indicate if the requesting BS 601 is able to join the respective CSF 500 at the requested BS slot or if a joining error has occurred. Joining errors may include, but are not limited to, a determination that a requested BS slot (e.g., of the one or more BS slots 502a-n) is already reserved by a different BS, a BS with a same identifier as the requesting BS 601 is already associated with the respective CCBS (e.g., the CCBS 102a), and/or a determination that the requesting BS 601 is associated with incompatible software and/or hardware such that the requesting BS 601 cannot successfully communicate with the one or more other components associated with the respective CCBS (e.g., one or more BSs 104a-c, UEs 106a-c, and/or trackers 108a-c associated with the respective CCBS 102a).

At operation 612, the apparatus 200 associated with the target BS 602 is configured to generate, based in part on the determination of whether the requesting BS 601 can join the CSF 500, a join response message. For example, the target BS 602 may generate, in response to receiving a join message from the requesting BS 601, one or more join response messages based at least in part on one or more join response message parameters. In various embodiments, the one or more join response message parameters comprise at least one of a join response message identifier, a BS identifier (e.g., a 64-bit BS ID), the requested BS slot (e.g., a requested BS slot of the one or more BS slots 502a-n), and/or a join status indication.

At operation 614, the apparatus 200 associated with the target BS 602 is configured to transmit the join response message to the requesting BS 601. In various embodiments, the target BS 602 can transmit the join response message to the requesting BS 601 during the command response slot 508 associated with the CSF 500.

At operation 616, the apparatus 200 associated with the requesting BS 601 is configured to receive the join response message from the target BS 602.

At optional operation 618, the apparatus 200 associated with the requesting BS 601 is configured to join the CSF at the requested BS slot associated with the join message. For example, if the target BS 602 determined that the requesting BS 601 is able to join the CSF 500 (e.g., the requested BS slot was available and the requesting BS 601 comprises compatible software and/or hardware), the requesting BS 601 can begin transmitting BS messages during the respective BS slot of the one or more BS slots 502a-n associated with the CSF 500.

In various embodiments, a BS (e.g., the requesting BS 601) can initiate the method 600 associated with the CSF joining procedure as a result of receiving a collision message indicating that the BS (e.g., the requesting BS 601) was involved in a BS transmission collision, where the BS transmission collision is an instance in which two or more BSs of the one or more BSs associated with a respective CCBS (e.g., the CCBS 102a) have transmitted respective BS messages via a common BS slot (e.g., BS slot 502a) associated with a respective CSF 500. If a BS (e.g., the requesting BS 601) receives the collision message and determines that the BS (e.g., the requesting BS 601) is not an initiator BS of the CSF 500, the BS (e.g., the requesting BS 601) can initiate the method 600 associated with the CSF joining procedure in order to obtain an unreserved BS slot of the one or more BS slots associated with the CSF 500.

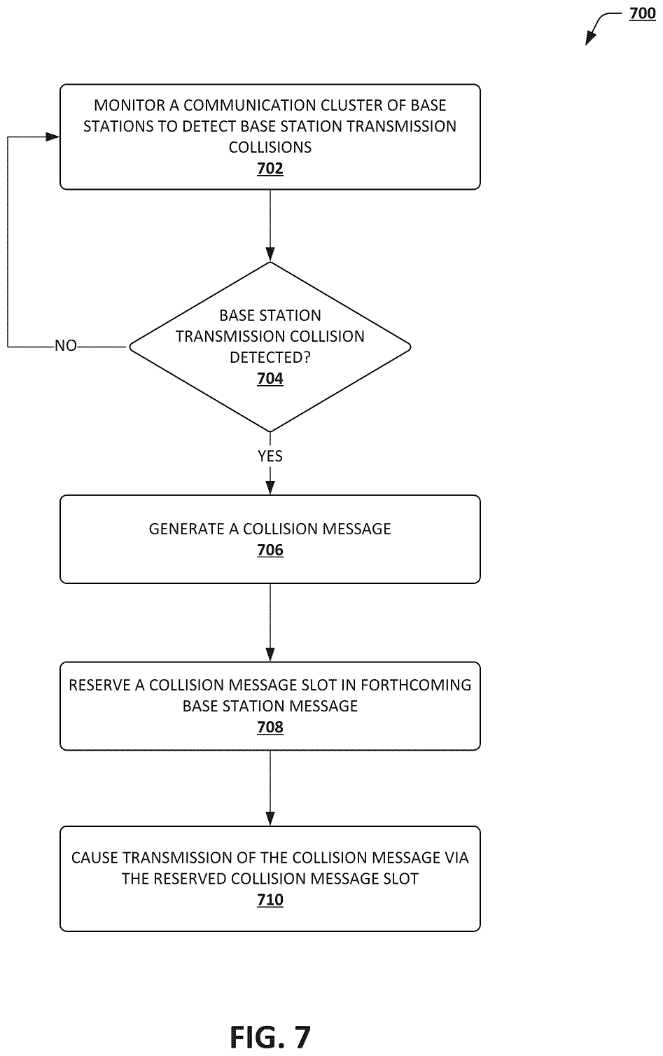

FIG. 7 illustrates a flowchart depicting a method 700 for mitigating a BS transmission collision in accordance with one or more example embodiments of the present disclosure. The method 700 can be implemented, for example, by one or more components of an apparatus 200. In various embodiments the apparatus 200 can be embodied can be embodied by a networking clement (e.g., a BS 104a). In various other embodiments, the apparatus 200 can be embodied by a UE 106a. Additionally or alternatively, the apparatus 200 can be embodied by any other particular computing device (e.g., autonomous robot, IoT device, smartphone, laptop, tablet computer, networking device, etc.) associated with a particular communications network. It will be appreciated that the apparatus 200 may be configured to perform the method 700 with the reference to the components of the apparatus 200 again being provided by way of example but not of limitation. As such, the apparatus 200 includes means, such as the processing circuitry 202, at least one processor, communication circuitry 204, at least one memory 206, data storage circuitry 212, and/or the like, configured to perform the various operations associated with the method 700.

The method 700 begins at operation 702 in which an apparatus 200 associated with a BS (e.g., BS 104a) is configured to monitor a respective CCBS (e.g., CCBS 102a) to detect BS transmission collisions.

At operation 704, the apparatus 200 associated with the BS (e.g., the BS 104a) is configured to determine whether a BS transmission collision has been detected. If no BS transmission collision has been detected, the method 700 reverts to operation 702 in which the apparatus 200 is configured to monitor a respective CCBS (e.g., the CCBS 102a) to detect BS transmission collisions. If a BS transmission collision has been detected, the method 700 proceeds to operation 706.

In various contexts, the BS (e.g. the BS 104a) that detects the BS transmission collision may be a respective BS involved in the BS transmission collision (e.g., one of the BSs transmitting a BS message in a same BS slot as one or more other BSs). In various other contexts, the BS (e.g. the BS 104a) that detects the BS transmission collision may be a BS that is not involved in the BS transmission collision.

At operation 706, the apparatus 200 associated with the BS (e.g., the BS 104a) is configured to generate a collision message in response to detecting that a BS transmission collision has occurred. In various embodiments, the collision message is used to report that two or more BSs (e.g., BSs 104a-c) associated with the respective CCBS (e.g., the CCBS 102a) have transmitted two or more respective BS messages during a same BS slot (e.g., BS slot 502a) associated with a respective CSF (e.g., a respective CSF 500). In various embodiments, the collision message comprises a collision message identifier and a BS slot number associated with a common BS slot associated with the BS transmission collision.

At operation 708, the apparatus 200 associated with the BS (e.g., the BS 104a) is configured to reserve a collision message slot in a forthcoming BS message associated with the apparatus 200. The apparatus 200 can transmit the collision message during the reserved collision message slot.

At operation 710, the apparatus 200 associated with the BS (e.g., the BS 104a) is configured to cause transmission of the collision message via the reserved collision message slot. In various contexts, the two or more BSs (e.g., BSs 104a-c) that were involved in the BS transmission collision can determine that the two or more BSs (e.g., BSs 104a-c) were involved in the BS transmission collision based in part on the BS slot number associated with the collision message in the reserved collision message slot. The two or more BSs (e.g., BSs 104a-c) that were involved in the BS transmission collision are removed from the CSF 500 and are directed to execute the CSF joining procedure again. However, if a first BS (e.g., BS 104a) of the two or more BSs (e.g., BS 104a-c) that were involved in the BS transmission collision is an initiator BS, the first BS (e.g., the BS 104a) is given priority and, as such, only the other BSs (e.g., BSs 104b-c) are directed to execute the CSF joining procedure again.

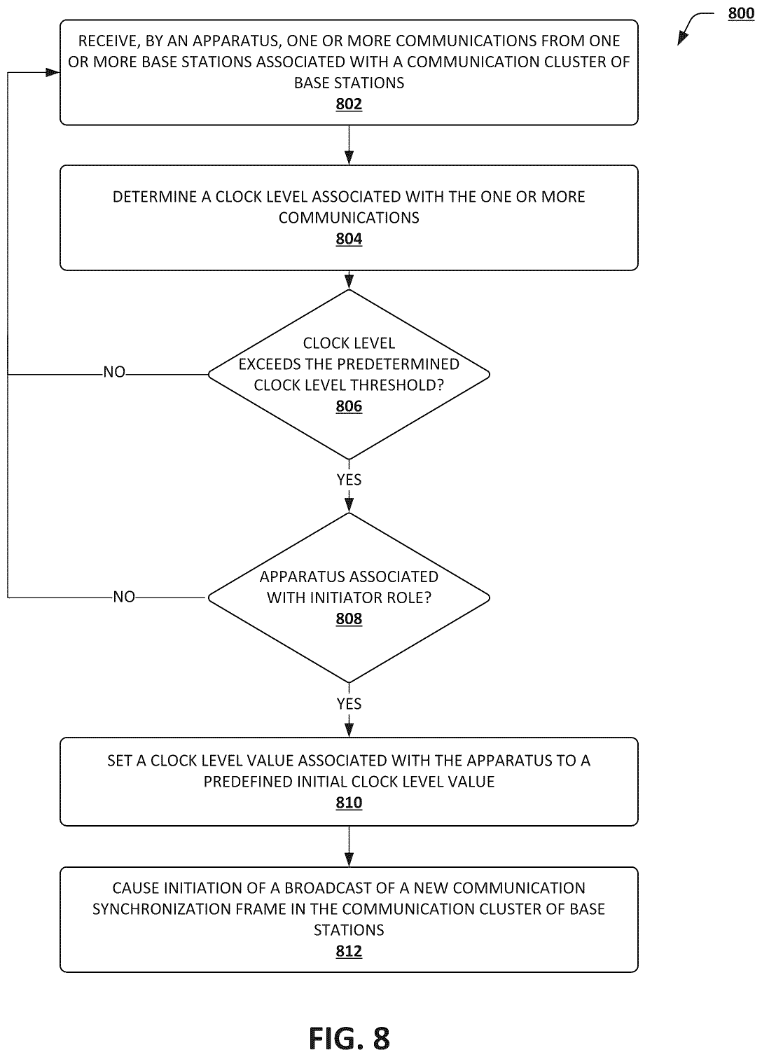

FIG. 8 illustrates a flowchart depicting a method 800 for managing one or more CSFs based in part on a predetermined clock level threshold in accordance with one or more example embodiments of the present disclosure. The method 800 can be implemented, for example, by one or more components of an apparatus 200. In various embodiments the apparatus 200 can be embodied can be embodied by a networking element (e.g., a BS 104a). In various other embodiments, the apparatus 200 can be embodied by a UE 106a. Additionally or alternatively, the apparatus 200 can be embodied by any other particular computing device (e.g., autonomous robot, IoT device, smartphone, laptop, tablet computer, networking device, etc.) associated with a particular communications network. It will be appreciated that the apparatus 200 may be configured to perform the method 800 with the reference to the components of the apparatus 200 again being provided by way of example but not of limitation. As such, the apparatus 200 includes means, such as the processing circuitry 202, at least one processor, communication circuitry 204, at least one memory 206, data storage circuitry 212, and/or the like, configured to perform the various operations associated with the method 800.

The method 800 begins at operation 802 in which an apparatus 200 associated with a BS (e.g., BS 104a) is configured to receive one or more communications from one or more BSs (e.g., BSs 104b-c) associated with a respective CCBS (e.g., CCBS 102a). For example, as described herein, the apparatus 200 is configured to receive from one or more BSs (e.g., the BSs 104a-c) one or more BS messages, one or more almanac messages, one or more join messages, and/or one or more collision messages transmitted during one or more respective transmission time slots associated with a respective CSF 500 broadcast the CCBS (e.g., the CCBS 102a).

At operation 804 the apparatus 200 associated with the BS (e.g., the BS 104a) is configured to determine a clock level associated with the one or more communications. For example, as described herein, the one or more BS messages associated with the one or more communications may comprise one or more respective portions of clock level data associated with a respective, current clock level value associated with the BSs (e.g., the BSs 104b-c) transmitting the BS messages during the respective BS slots of the CSF 500.

At operation 806 the apparatus 200 associated with the BS (e.g., the BS 104a) is configured to determine if the clock level associated with the one or more communications exceeds a predetermined clock level threshold. For example, in various embodiments, if the apparatus 200 associated with the BS (e.g., the BS 104) detects a clock level value associated with a respective BS message exceeds a preselected value (e.g., a clock level value determined via a function such as rand(5, 20)) the BS may determine that the an initiator BS has malfunctioned and/or otherwise ceased to send BS messages. If the determined clock level does not exceed the predetermined clock level threshold, the method 800 may revert to operation 802. However, if the determined clock level does exceed the predetermined clock level threshold, the method 800 may proceed to operation 808.

At operation 808 the apparatus 200 associated with the BS (e.g., the BS 104a) is configured to determine whether the BS is associated with an initiator role. As described herein, one or more BSs (e.g., BSs 104a-c) associated with a particular CCBS (e.g., the CCBS 102a) may be associated (e.g., assigned and/or pre-configured) with an initiator role which indicates that the one or more respective BSs associated with the initiator role can initiate the broadcast of a CSF 500 across the particular CCBS 102a. If the BS (e.g., the BS 104a) is not associated with an initiator role, the method 800 may revert to operation 802. However, if the BS (e.g., the BS 104a) is associated with an initiator role, the method 800 may proceed to operation 810.

At operation 810 the apparatus 200 associated with the BS (e.g., the BS 104a) is configured to set a clock level value associated with the apparatus 200 to a predefined initial clock level value. For example, the BS (e.g., the BS 104a) associated with an initiator role can operate as an initiator BS. As such, the BS (e.g., the BS 104a) labeled as the initiator BS may set a clock level value associated with the BS to a predefined initial clock level value (e.g., an initial clock level value of 0) and indicate the clock level to the other BSs associated with the respective CCBS (e.g., BSs 104b-c of the CCBS 102a) via a respective BS message (e.g., a first BS message of one or more BS messages associated with a first CSF 500 initiated by the BS labeled as the initiator BS). The other BSs associated with the respective CCBS (e.g., the BSs 104b-c of the CCBS 102a) may determine a value of a smallest received clock level from the one or more BS messages associated with a respective CSF 500 (e.g., the first CSF), increment the value of the smallest received clock level by a predefined amount (e.g., a value of 1), and set a respective clock level value associated with the other respective BSs (e.g., BSs 104b-c) based on the incremented value.

For example, as described herein, a second BS (e.g., the BS 104b) may determine a value of a smallest received clock level from the first BS (e.g., the BS 104a), increment the value of the smallest received clock level by a predefined amount (e.g., a value of 1), and set a clock level value associated with the second BS (e.g., the BS 104b) based on the incremented value. Subsequently, a third BS (e.g., the BS 104c) may determine a value of a smallest received clock level from the second BS (e.g., the BS 104b), increment the value of the smallest received clock level by a predefined amount (e.g., a value of 1), and set a clock level value associated with the third BS (e.g., the BS 104c) based on the incremented value. In this regard, the respective BSs (e.g., BSs 104b-c) can store the respective incremented clock level values as a respective clock level and indicate the respective clock level in one or more subsequent BS messages transmitted by the respective BSs (e.g., BSs 104b-c).

At operation 812 the apparatus 200 associated with the BS (e.g., the BS 104a) is configured to cause initiation of a broadcast of a new CSF 500 in the respective CCBS (e.g., CCBS 102a). The BS (e.g., the BS 104a), now associated with an initiator role, can operate as an initiator BS and, as such, cause the broadcast of one or more CSFs 500 across the respective CCBS (e.g., the CCBS 102a). As such, the one or more respective BSs (e.g. the BSs 104b-c) can determine one or more respective clock levels associated with the one or more respective BSs (e.g. the BSs 104b-c).

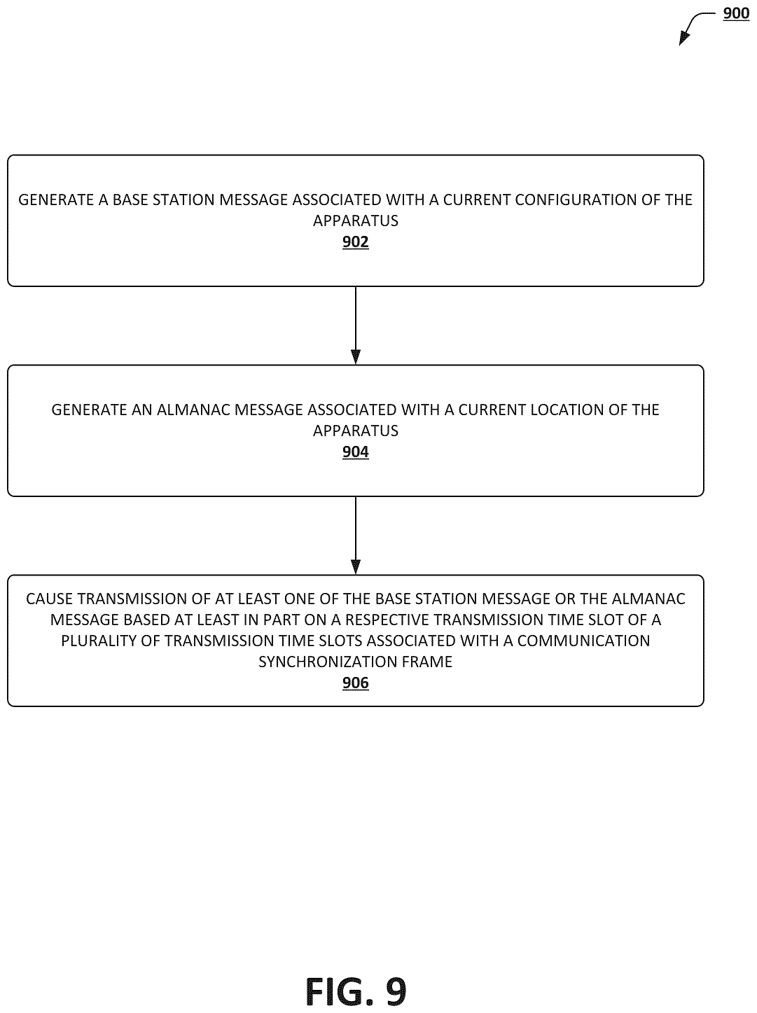

FIG. 9 illustrates a flowchart depicting a method 900 for transmitting one or more BS messages and/or almanac messages associated with a respective CSF in accordance with one or more example embodiments of the present disclosure. The method 900 can be implemented, for example, by one or more components of an apparatus 200. In various embodiments the apparatus 200 can be embodied can be embodied by a networking element (e.g., a BS 104a). In various other embodiments, the apparatus 200 can be embodied by a UE 106a. Additionally or alternatively, the apparatus 200 can be embodied by any other particular computing device (e.g., autonomous robot, IoT device, smartphone, laptop, tablet computer, networking device, etc.) associated with a particular communications network. It will be appreciated that the apparatus 200 may be configured to perform the method 900 with the reference to the components of the apparatus 200 again being provided by way of example but not of limitation. As such, the apparatus 200 includes means, such as the processing circuitry 202, at least one processor, communication circuitry 204, at least one memory 206, data storage circuitry 212, and/or the like, configured to perform the various operations associated with the method 900.

The method 900 begins at operation 902 in which the apparatus 200 is configured to generate a BS message associated with a current configuration of the apparatus 200, where the BS message is configured based at least in part on one or more BS message parameters associated with one or more portions of data related to the current configuration of the apparatus 200.

At operation 904, the apparatus 200 is configured to generate an almanac message associated with a current location of the apparatus 200, wherein the almanac message is configured based at least in part on one or more almanac message parameters associated with one or more portions of data related to the current location of the apparatus 200.

At operation 906, the apparatus 200 is configured to cause transmission of at least one of the BS message or the almanac message based at least in part on a respective transmission time slot of a plurality of transmission time slots associated with a CSF 500, where the CSF 500 is broadcast across a respective CCBS (e.g., the CCBS 102a), and where the CSF 500 is configured to synchronize one or more communications of one or more BSs (e.g., BSs 104a-c) associated with the respective CCBS (e.g., the CCBS 102a).

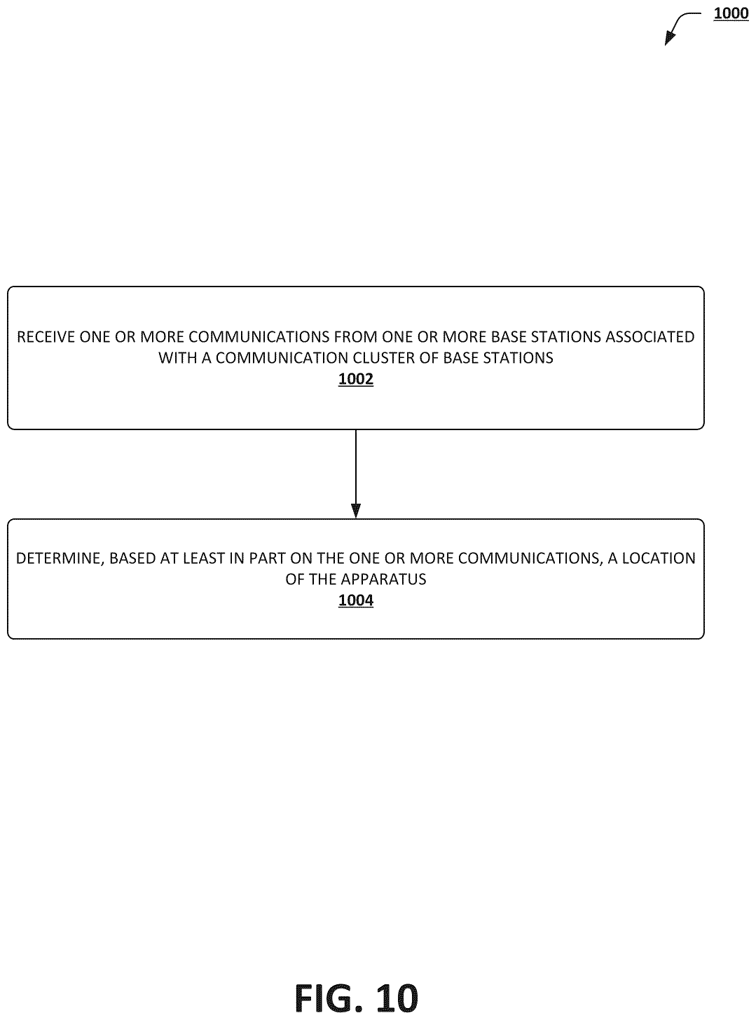

FIG. 10 illustrates a flowchart depicting a method 1000 for determining a position of an apparatus associated with a respective CCBS based in part on one or more messages associated with a respective CSF in accordance with one or more example embodiments of the present disclosure. The method 1000 can be implemented, for example, by one or more components of an apparatus 200. In various embodiments the apparatus 200 can be embodied can be embodied by a networking element (e.g., a BS 104a). In various other embodiments, the apparatus 200 can be embodied by a UE 106a. Additionally or alternatively, the apparatus 200 can be embodied by any other particular computing device (e.g., autonomous robot, IoT device, smartphone, laptop, tablet computer, networking device, etc.) associated with a particular communications network. It will be appreciated that the apparatus 200 may be configured to perform the method 1000 with the reference to the components of the apparatus 200 again being provided by way of example but not of limitation. As such, the apparatus 200 includes means, such as the processing circuitry 202, at least one processor, communication circuitry 204, at least one memory 206, data storage circuitry 212, and/or the like, configured to perform the various operations associated with the method 1000.

The method 1000 begins at operation 1002 in which the apparatus 200 is configured to receive one or more communications from one or more BSs (e.g., BSs 104a-c) associated with a CCBS (e.g., CCBS 102a), where the one or more communications are associated with one or more respective transmission time slots associated with a CSF 500, and where the one or more communications comprise at least one of one or more BS messages associated with a current configuration of the one or more respective BSs (e.g., the BSs 104a-c) or one or more almanac messages associated with a current location of the one or more respective BSs (e.g., the BSs 104a-c).

At operation 1004, the apparatus 200 is configured to determine, based at least in part on the one or more communications, a location of the apparatus 200.

### CONCLUSION

It will be appreciated that the example embodiments described herein are not restricted to any system that is given as an example, such as a 5G system, and that a person skilled in the art may apply the solution to other communication systems. Furthermore, implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

A computer program, such as the computer program(s) described herein, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

It will be understood that each block of the flowchart(s) and combination of blocks in the flowchart(s) can be implemented by various means, such as hardware, firmware, processor, circuitry, and/or other communication devices associated with execution of software including one or more computer program instructions. For example, one or more of the procedures described herein can be embodied by computer program instructions. In this regard, the computer program instructions which embody the procedures described herein can be stored, for example, by the memory 206 of the apparatus 200 or other apparatus employing an embodiment of the present disclosure and executed by the processing circuitry 202. As will be appreciated, any such computer program instructions can be loaded onto a computer or other programmable apparatus (for example, hardware) to produce a machine, such that the resulting computer or other programmable apparatus implements the functions specified in the blocks of the flowchart(s). These computer program instructions can also be stored in a computer-readable memory that can direct a computer or other programmable apparatus to function in a particular manner, such that the instructions stored in the computer-readable memory produce an article of manufacture the execution of which implements the function specified in the blocks of the flowchart(s). The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flowchart(s).

Accordingly, blocks of the flowchart(s) support combinations of means for performing the specified functions and combinations of operations for performing the specified functions for performing the specified functions. It will also be understood that one or more blocks of the flowchart(s), and combinations of blocks in the flowchart(s), can be implemented by special purpose hardware-based computer systems which perform the specified functions, or combinations of special purpose hardware and computer instructions.

In some embodiments, certain ones of the operations described herein may be modified or further amplified. Furthermore, in some embodiments, additional optional operations may be included. Modifications, additions, or amplifications to the operations described herein may be performed in any order and in any combination.

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What which is claimed:

1. An apparatus comprising:
at least one processor; and
at least one memory including computer program code, the at least one memory and the computer program code configured to, with the at least one processor, cause the apparatus at least to:
generate a base station message associated with a current configuration of the apparatus, wherein the base station message is configured based at least in part on one or more base station message parameters associated with one or more portions of data related to the current configuration of the apparatus;
generate an almanac message associated with a current location of the apparatus, wherein the almanac message is configured based at least in part on one or more almanac message parameters associated with one or more portions of data related to the current location of the apparatus; and
cause transmission of at least one of the base station message or the almanac message based at least in part on a respective transmission time slot of a plurality of transmission time slots associated with a communication synchronization frame, wherein the communication synchronization frame is broadcast across a communication cluster of base stations (CCBS), and wherein the communication synchronization frame is configured to synchronize one or more communications of one or more base stations associated with the CCBS.

2. The apparatus of claim 1, wherein the communication synchronization frame is configured based at least in part on the plurality of transmission time slots, and wherein the plurality of transmission time slots comprises at least one of one or more base station slots, one or more almanac slots, one or more command slots, one or more command response slots, or one or more common slots.

3. The apparatus of claim 1, wherein the computer program code is further configured to, with the at least one processor, cause the apparatus to:
determine that the apparatus is associated with an initiator role, wherein the initiator role indicates that the apparatus is configured to set a timing synchronization associated with the communication synchronization frame for the one or more base stations associated with the CCBS; and
in response to determining that the apparatus is associated with the initiator role:
set a clock level value associated with the apparatus to a predefined initial clock level value; and
cause initiation of the broadcast of the communication synchronization frame in the CCBS.

4. The apparatus of claim 1, wherein the computer program code is further configured to, with the at least one processor, cause the apparatus to:
prior to generating and causing the transmission of the at least one of the base station message or the almanac message:
determine whether the apparatus has an assigned base station slot associated with the communication synchronization frame; and
in response to determining the apparatus does not have an assigned base station slot:
join the communication synchronization frame by at least:
generating a join message, wherein the join message is a request to cause the apparatus to join the communication synchronization frame at a requested base station slot; and
causing transmission of the join message during a command slot associated with the communication synchronization frame.

5. The apparatus of claim 4, wherein the join message is associated with one or more join message parameters, and wherein the one or more join message parameters comprise at least one of a join message identifier, a base station identifier, a hardware version number, a software version number, a software checksum, or the requested base station slot.

6. The apparatus of claim 5, wherein the join message is transmitted to a target base station of the one or more base stations based on an amount of communication synchronization frames the target base station has been associated with relative to the one or more respective base stations.

7. The apparatus of claim 6, wherein the computer program code is further configured to, with the at least one processor, cause the apparatus to:
in response to causing the transmission of the join message:
receive, from the target base station, a join response message;
determine, based on the join response message, whether the apparatus is able to join the communication synchronization frame at the requested base station slot; and
in response to determining that the apparatus is able to join the communication synchronization frame:
join the communication synchronization frame at the requested base station slot.

8. The apparatus of claim 7, wherein the join response message comprises one or more join response message parameters, and wherein the one or more join response message parameters comprise at least one of a join response message identifier, the base station identifier, the requested base station slot, or a join status indication.

9. The apparatus of claim 1, wherein the computer program code is further configured to, with the at least one processor, cause the apparatus to:
detect a base station transmission collision, wherein the base station transmission collision is an instance in which two or more base stations of the one or more base stations associated with the CCBS have transmitted respective base station messages via a common base station slot associated with the communication synchronization frame;
in response to detecting the base station transmission collision:
generate a collision message, wherein the collision message comprises a collision message identifier and a base station slot number associated with the common base station slot associated with the base station transmission collision;
reserve a collision message slot in a forthcoming base station message associated with the apparatus; and
cause transmission of the collision message via the reserved collision message slot during transmission of the forthcoming base station message.

10. An apparatus comprising:
at least one processor; and
at least one memory including computer program code, the at least one memory and the computer program code configured to, with the at least one processor, cause the apparatus at least to:
receive one or more communications from one or more base stations associated with a CCBS, wherein the one or more communications are associated with one or more respective transmission time slots associated with a communication synchronization frame,
wherein the one or more communications comprise at least one of one or more base station messages associated with a current configuration of the one or more respective base stations or one or more almanac messages associated with a current location of the one or more respective base stations; and
determine, based at least in part on the one or more communications, a location of the apparatus.

11. The apparatus of claim 10, wherein the computer program code is further configured to, with the at least one processor, cause the apparatus to:
determine a value of a smallest received clock level from one or more base station messages associated with the one or more respective communications;
increment the value of the smallest received clock level by a predefined amount; and
set a clock level value associated with the apparatus based on the incremented value, wherein the clock level value will be indicated in one or more subsequent base station messages transmitted by the apparatus.

12. The apparatus of claim 11, wherein the computer program code is further configured to, with the at least one processor, cause the apparatus to:
determine whether a value of a clock level associated with a respective base station message of the one or more base station messages associated with the one or more communications exceeds a predetermined clock level threshold;
in response to determining that the value of the clock level associated with the respective base station message exceeds the predetermined clock level threshold:
determine whether the apparatus is associated with an initiator role, wherein the initiator role indicates that the apparatus is configured to set a timing synchronization associated with the communication synchronization frame for the one or more base stations associated with the CCBS;
in response to determining that the apparatus is associated with the initiator role:
set a clock level value associated with the apparatus to a predefined initial clock level value; and
cause initiation of a broadcast of a new communication synchronization frame in the CCBS.

13. The apparatus of claim 10, wherein the computer program code is further configured to, with the at least one processor, cause the apparatus to:
receive a join message from a requesting base station of the one or more base stations associated with the CCBS, wherein the join message is a request to cause the requesting base station to join the communication synchronization frame at a requested base station slot;
in response to receiving the join message from the requesting base station:
determine, based at least in part on the join message, whether the requesting base station is able to join the communication synchronization frame;
generate, based on determining whether the requesting base station is able to join the communication synchronization frame, a join response message; and
cause transmission of the join response message to the requesting base station.

14. The apparatus of claim 13, wherein the join response message comprises one or more join response message parameters, and wherein the one or more join response message parameters comprise at least one of a join response message identifier, a base station identifier associated with the requesting base station, the requested base station slot, or a join error indication.

15. The apparatus of claim 10, wherein the computer program code is further configured to, with the at least one processor, cause the apparatus to:
receive a collision message;
in response to receiving the collision message:
determine if the apparatus is an initiator of the communication synchronization frame; and
in response to determining that the apparatus is not the initiator of the communication synchronization frame:
join the communication synchronization frame by at least:
generating a join message, wherein the join message is a request to cause the apparatus to join the communication synchronization frame at a requested base station slot; and
causing transmission of the join message during a command slot associated with the communication synchronization frame;
receiving, from a target base station, a join response message in response to transmitting the join message during the command slot;
determining, based on the join response message, whether the apparatus is able to join the communication synchronization frame at the requested base station slot; and
in response to determining that the apparatus is able to join the communication synchronization frame:
join the communication synchronization frame at the requested base station slot.

16. A computer-implemented method, the computer-implemented method comprising:
generating, by an apparatus, a base station message associated with a current configuration of the apparatus, wherein the base station message is configured based at least in part on one or more base station message parameters associated with one or more portions of data related to the current configuration of the apparatus;
generating an almanac message associated with a current location of the apparatus, wherein the almanac message is configured based at least in part on one or more almanac message parameters associated with one or more portions of data related to the current location of the apparatus; and
causing transmission of at least one of the base station message or the almanac message based at least in part on a respective transmission time slot of a plurality of transmission time slots associated with a communication synchronization frame, wherein the communication synchronization frame is broadcast across a communication cluster of base stations (CCBS), and wherein the communication synchronization frame is configured to synchronize one or more communications of one or more base stations associated with the CCBS.

17. The computer-implemented method of claim 16, wherein the communication synchronization frame is configured based at least in part on the plurality of transmission time slots, and wherein the plurality of transmission time slots comprises at least one of one or more base station slots, one or more almanac slots, one or more command slots, one or more command response slots, or one or more common slots.

18. The computer-implemented method of claim 16, wherein the computer-implemented method further comprises:
determining that the apparatus is associated with an initiator role, wherein the initiator role indicates that the apparatus is configured to set a timing synchronization associated with the communication synchronization frame for the one or more base stations associated with the CCBS; and
in response to determining that the apparatus is associated with the initiator role:
setting a clock level value associated with the apparatus to a predefined initial clock level value; and
causing initiation of the broadcast of the communication synchronization frame in the CCBS.

19. The computer-implemented method of claim 16, wherein the computer-implemented method further comprises:
prior to generating and causing the transmission of the at least one of the base station message or the almanac message:
determining whether the apparatus has an assigned base station slot associated with the communication synchronization frame; and
in response to determining the apparatus does not have an assigned base station slot:
joining the communication synchronization frame by at least:
generating a join message, wherein the join message is a request to cause the apparatus to join the communication synchronization frame at a requested base station slot; and
causing transmission of the join message to a target base station during a command slot associated with the communication synchronization frame.

20. The computer-implemented method of claim 19, wherein the computer-implemented method further comprises:
in response to causing the transmission of the join message:
receiving, from the target base station, a join response message;
determining, based on the join response message, whether the apparatus is able to join the communication synchronization frame at the requested base station slot; and
in response to determining that the apparatus is able to join the communication synchronization frame:
joining the communication synchronization frame at the requested base station slot.
